(19) United States
(12) Patent Application Publication
(10) Pub. No.: US 2026/0028200 A1
(43) Pub. Date: Jan. 29, 2026

(54) MATERIAL WRAPPING SYSTEM AND WRAPPING A MATERIAL SHEET AROUND A LONGITUDINAL COMPONENT

(71) Applicant: The Boeing Company, Arlington, VA (US)

(72) Inventors: Shuonan Dong, Seattle, WA (US); David John Dahl, Everett, WA (US); Keegan David Bray, Auburn, WA (US); Zena Lissette Moran Valenzuela, Everett, WA (US); Asher Seth Einhorn, Seattle, WA (US)

(21) Appl. No.: 19/342,183

(22) Filed: Sep. 26, 2025

Related U.S. Application Data
(63) Continuation-in-part of application No. 18/651,347, filed on Apr. 30, 2024.

(51) Int. Cl. B65H 16/00; B64F 5/10; B65H 23/08

(52) U.S. Cl. CPC B65H 16/005; B65H 23/08; B64F 5/10; B65H 2701/1944

(57) ABSTRACT

A material wrapping system is presented. The material wrapping system comprises a material sheet tensioning dispenser comprising a positional lock configured to lock the material wrapping system relative to a track system, a material roll support, and a tensioning system configured to selectively prevent rotation of a material roll on the material roll support; and a movable carriage configured to wrap a material sheet dispensed from the material roll around a longitudinal component using side wheels and top wheels configured to guide the material sheet against the longitudinal component as the movable carriage moves towards the material sheet tensioning dispenser.

### CROSS-REFERENCE TO RELATED APPLICATION

This application is a Continuation in Part of U.S. patent application Ser. No. 18/651,347, filed Apr. 30, 2024, and entitled “Movable Carriage and Wrapping a Material Sheet Around a Longitudinal Component,” which is incorporated herein by reference in its entirety.

### BACKGROUND INFORMATION

### 1. Field

The present disclosure relates generally to a material wrapping system and methods for wrapping a material sheet around a longitudinal component.

### 2. Background

In manufacturing processes, a material sheet can be wrapped around a component for a variety of reasons, for example to provide desired surface properties and/or functionality during manufacturing. Accordingly, some material sheets can take the form of a breather or a release film. Material sheets can also be wrapped around a manufacturing tool or a product.

Therefore, it would be desirable to have a method and apparatus that takes into account at least some of the issues discussed above, as well as other possible issues. It would be desirable to at least one of more easily or more quickly wrap a material sheet around a component.

### SUMMARY

Embodiments of the present disclosure provide a material wrapping system. The material wrapping system comprises a material sheet tensioning dispenser and a movable carriage. The material sheet tensioning dispenser comprises a positional lock configured to lock the material wrapping system relative to a track system, a material roll support, and a tensioning system configured to selectively prevent rotation of a material roll on the material roll support. The movable carriage is configured to wrap a material sheet dispensed from the material roll around a longitudinal component using side wheels and top wheels configured to guide the material sheet against the longitudinal component as the movable carriage moves towards the material sheet tensioning dispenser.

Another embodiment of the present disclosure provides a method of wrapping a material sheet around a longitudinal component. A first length of a material sheet is dispensed from a material roll in a material sheet tensioning dispenser onto a work table. The material sheet tensioning dispenser is locked in a location on the work table. A longitudinal component is positioned over the first length of the material sheet on the work table. The material roll within the material sheet tensioning dispenser is locked using a tensioning system to maintain tension on the material sheet. A movable carriage is positioned such that the longitudinal component is within an operating volume beneath a frame of the movable carriage. The movable carriage is moved in a direction parallel to a longitudinal axis of the longitudinal component a first distance towards the material sheet tensioning dispenser to guide at least a portion of the first length of the material sheet around the longitudinal component as the material sheet tensioning dispenser maintains tension on the material sheet.

Yet another embodiment of the present disclosure provides a material sheet tensioning dispenser. The material sheet tensioning dispenser comprises a positional lock, a material roll support, and a tensioning system. The positional lock is configured to maintain a position of the material sheet tensioning dispenser relative to a work table. The material roll support is configured to rotatably support a material roll. The tensioning system is configured to selectively prevent rotation of a material roll on the material roll support.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view of a longitudinal component with a plurality of material sheets in accordance with an illustrative embodiment;

FIG. 4 is an illustration of an isometric view of a movable carriage applying a material sheet around a longitudinal component in accordance with an illustrative embodiment;

FIG. 5 is an illustration of a top view of a movable carriage applying a material sheet around a longitudinal component in accordance with an illustrative embodiment;

FIG. 6 is an illustration of a front cross-sectional view of a movable carriage applying a material sheet around a longitudinal component in accordance with an illustrative embodiment;

FIG. 7 is an illustration of a side view of a movable carriage applying a material sheet around a longitudinal component in accordance with an illustrative embodiment;

FIG. 8 is a flowchart of a method of wrapping a material sheet around a longitudinal component in accordance with an illustrative embodiment;

FIG. 9 is an illustration of an aircraft manufacturing and service method in a form of a block diagram in accordance with an illustrative embodiment;

FIG. 10 is an illustration of an aircraft in a form of a block diagram in which an illustrative embodiment may be implemented;

FIG. 11 is an illustration of a block diagram of a manufacturing environment in accordance with an illustrative embodiment;

FIG. 12 is an illustration of a material sheet tensioning dispenser within a manufacturing environment in accordance with an illustrative embodiment;

FIG. 13 is an illustration of a material sheet tensioning dispenser within a manufacturing environment in accordance with an illustrative embodiment;

FIG. 14 is an illustration of a material wrapping system within a manufacturing environment in accordance with an illustrative embodiment;

FIG. 15 is an illustration of a material wrapping system within a manufacturing environment in accordance with an illustrative embodiment;

FIG. 16 is an illustration of portions of a material wrapping system within a manufacturing environment in accordance with an illustrative embodiment;

FIG. 17 is an illustration of an auxiliary cart within a manufacturing environment in accordance with an illustrative embodiment; and

FIGS. 18A and 18B are a flowchart of a method of wrapping a material sheet around a longitudinal component in accordance with an illustrative embodiment.

### DETAILED DESCRIPTION

The illustrative examples recognize and take into account several considerations. The illustrative embodiments recognize and take into account that during airplane fabrication, pressurized rubber bladders can be used inside stringer cavities to provide reaction and compaction forces to the un-cured composite bodies. The illustrative embodiments recognize and take into account that before use, bladders can be wrapped with layers of material to provide release or other manufacturing support.

The illustrative embodiments recognize and take into account that conventional bladder wrapping is performed by hand. During manual bladder wrapping the bladder is moved to a workstation using a gantry and the operator wraps each layer and tapes it by hand. The illustrative embodiments recognize and take into account that the manual process can take several hours. The illustrative embodiments recognize and take into account that it can be undesirably difficult to consistently apply the desired amount of tension over the length of the longitudinal component to prevent wrinkles.

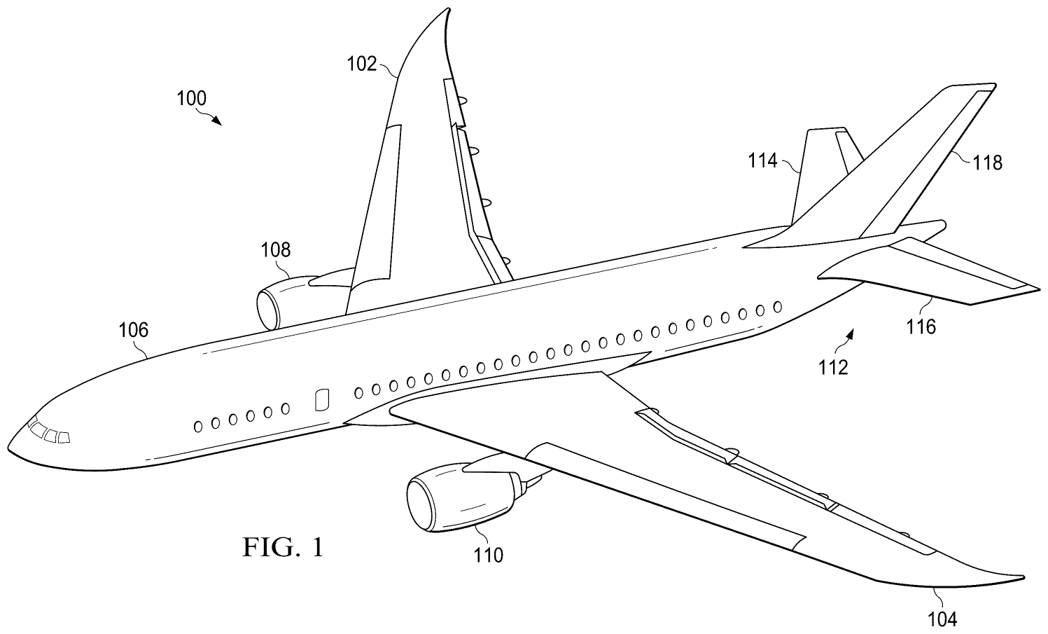

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

In some illustrative examples, components of aircraft 100 can be manufactured using longitudinal components wrapped using at least one of the movable carriage or disclosed methods. The movable carriage of the illustrative examples can be used to wrap a longitudinal component in manufacturing a component of aircraft 100. Aircraft 100 is an example of an aircraft that can have a part manufactured using the illustrative examples.

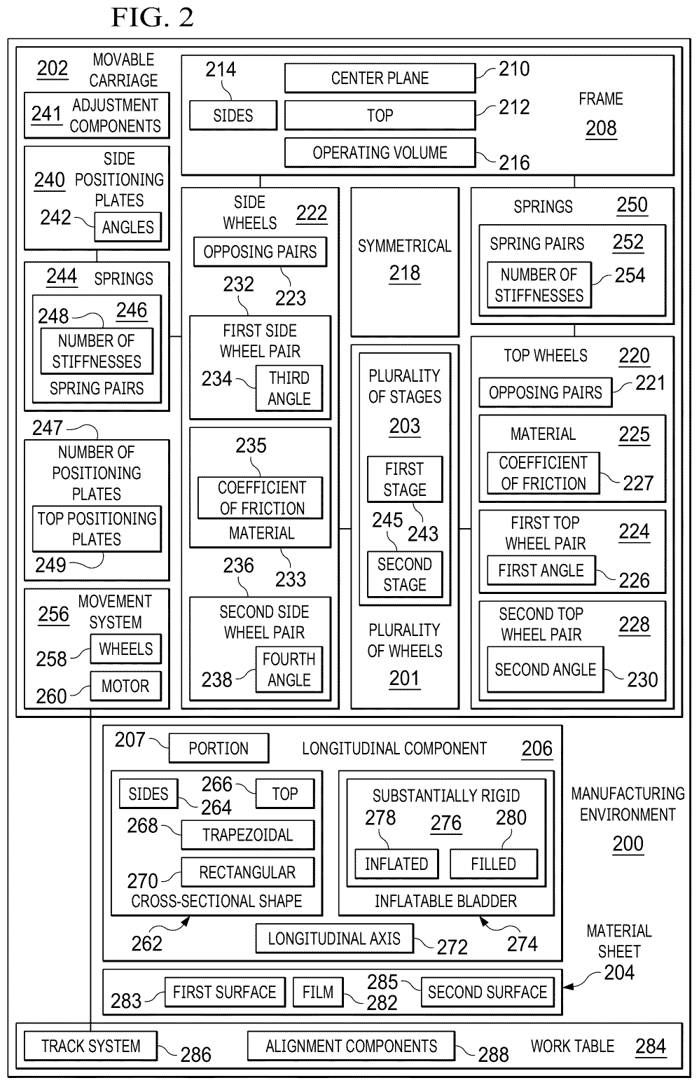

Turning now to FIG. 2, an illustration of a block diagram of a manufacturing environment is depicted in accordance with an illustrative embodiment. In manufacturing environment 200, movable carriage 202 can be used to wrap material sheet 204 around longitudinal component 206. Movable carriage 202 urges material sheet 204 up and around longitudinal component 206 as movable carriage 202 moves along longitudinal component 206. Movable carriage 202 is configured to wrap material sheet 204 around portion 207 of longitudinal component 206 disposed on material sheet 204.

Movable carriage 202 comprises plurality of wheels 201 positioned normal to an outer surface of longitudinal component 206. Movable carriage 202 comprises plurality of wheels 201 positioned normal to a perimeter of cross-sectional shape 262 of longitudinal component 206. In this illustrative example, plurality of wheels 201 is presented as top wheels 220 and side wheels 222. However, plurality of wheels 201 can be distributed within operating volume 216 in any desirable orientation based on cross-sectional shape 262 of longitudinal component 206 such that the plurality of wheels 201 is normal to a perimeter of cross-sectional shape 262. Angles of plurality of wheels 201 relative to the movement direction of movable carriage 202 drive wrapping of material sheet 204 around longitudinal component 206.

Movable carriage 202 comprises frame 208, plurality of wheels 201 arranged as plurality of stages 203 offset from each other along center plane 210 of frame 208, and number of positioning plates 247 connected to frame 208 and holding plurality of wheels 201 normal to a cross-sectional shape of longitudinal component 206. Each stage of plurality of stages 203 is a subset of plurality of wheels 201 that is positioned on a same plane. Each plane is parallel to cross-sectional shape 262 of longitudinal component 206. Each plane is perpendicular to the center plane 210.

In some illustrative examples, plurality of wheels 201 is arranged in pairs. In some illustrative examples, plurality of wheels 201 can comprise at least one wheel without a counterpart.

Angles of wheels of each respective stage of plurality of stages 203 increase along center plane 210. For example, first stage 243 of plurality of wheels 201 encounter material sheet 204 first and have a number of angles smaller in magnitude than second stage 245 of plurality of wheels 201. The number of angles of wheels in second stage 245 is greater in magnitude to pull material sheet 204 tighter onto longitudinal component 206.

Number of positioning plates 247 comprises one or more positioning plates. In some illustrative examples, a position of each of number of positioning plates 247 is adjustable. Number of positioning plates 247 can be moved to adjust the position of plurality of wheels 201 within operating volume 216. Number of positioning plates 247 can be moved to adjust the normal force provided by plurality of wheels 201 to material sheet 204. Number of positioning plates 247 can be used to hold plurality of wheels 201 normal to an outer surface of longitudinal component 206. Number of positioning plates 247 can be used to hold plurality of wheels 201 normal to a perimeter of cross-sectional shape 262 of longitudinal component 206. Number of positioning plates 247 can be used to provide rigidity to counteract normal forces provided by plurality of wheels 201.

In some illustrative examples, number of positioning plates 247 is comprised of plates placed in parallel to some or all faces of outer surfaces of longitudinal component 206. In some illustrative examples, adjustment of some or all of number of positioning plates 247 maintains symmetric positions of plurality of wheels 201 with respect to longitudinal component 206. In some illustrative examples, adjustment of some or all of number of positioning plates 247 maintains consistent normal force provided by plurality of wheels 201 relative to one another.

Normal position of plurality of wheels 201 relative to cross-sectional shape 262 of longitudinal component 206 can be maintained through wheel mounts attached to frame 208. Normal position of plurality of wheels 201 relative to cross-sectional shape 262 of longitudinal component 206 can be maintained through wheel mounts attached to number of positioning plates 247. Normal position of plurality of wheels 201 relative to cross-sectional shape 262 of longitudinal component 206 can be maintained through clamping forces providing normal force to plurality of wheels 201. Clamping forces providing normal force to plurality of wheels 201 can be provided by mechanical systems, rigid components, forces external to frame 208, or other desirable sources. At least one of frame 208, number of positioning plates 247, or wheel mounts can include one or more mechanical degrees of freedom to maintain compliance with cross-sectional shape 262 of longitudinal component 206. At least one of frame 208, number of positioning plates 247, or wheel mounts can include flexible connections or materials to maintain compliance with cross-sectional shape 262 of longitudinal component 206. At least one of frame 208, number of positioning plates 247, or wheel mounts can include springs, such as springs 244 or springs 250, to maintain compliance with cross-sectional shape 262 of longitudinal component 206.

In some illustrative examples, adjustment components 241 are present between number of positioning plates 247 and frame 208. In some illustrative examples, adjustment components 241 take the form of lead screw assemblies or other types of adjustment components. Adjustment components 241 can be used to adjust the position of plurality of wheels 201 within operating volume 216. Adjustment components 241 can be used to adjust the normal force provided by plurality of wheels 201 to material sheet 204. In some illustrative examples, when present, the lead-screw assemblies provide sufficient locking force to enable number of positioning plates 247 to counteract normal forces from plurality of wheels 201.

Movable carriage 202 is configured to wrap material sheet 204 around longitudinal component 206. Movable carriage 202 is able to create a flat overlapped seam when material sheet 204 is wrapped around longitudinal component 206. Movable carriage 202 comprises frame 208, side wheels 222, and top wheels 220. Frame 208 defines center plane 210 and operating volume 216. Side wheels 222 are within operating volume 216 configured to guide material sheet 204 against sides 264 of portion 207 of longitudinal component 206 when disposed within operating volume 216 and aligned with center plane 210, as movable carriage 202 moves parallel to center plane 210. Side wheels 222 are arranged as one or more opposing pairs 223 about center plane 210. Top wheels 220 are within operating volume 216 and configured to guide material sheet 204 against top 266 of portion 207 of longitudinal component 206 as movable carriage 202 moves parallel to center plane 210. Top wheels 220 are arranged as one or more opposing pairs 221 about center plane 210.

Portion 207 of longitudinal component 206 is located in proximity to movable carriage 202 such that material sheet 204 adjacent to portion 207 is acted upon by movable carriage 202. In some illustrative examples, portion 207 is located within operating volume 216. In some illustrative examples, movement of movable carriage 202 causes lifting of material sheet 204 outside of operating volume 216. In these illustrative examples, portions of material sheet 204 begin lifting off of work table 284 and towards longitudinal component 206 before the portions of material sheet 204 are contacted by side wheels 222 and top wheels 220. In these illustrative examples, portions of material sheet 204 begin lifting off of work table 284 and towards longitudinal component 206 before the portions of material sheet 204 are positioned within frame 208.

In some illustrative examples, prior to wrapping material sheet 204 onto longitudinal component 206, material sheet 204 is placed onto work table 284. In some illustrative examples, material sheet 204 is placed flat onto work table 284 prior to wrapping material sheet 204 around longitudinal component 206. In some illustrative examples, the whole of longitudinal component 206 is placed onto the whole of material sheet 204 prior to wrapping. In some other illustrative examples, material sheet 204 is fed to portion 207 prior to wrapping material sheet 204 around portion 207 of longitudinal component 206.

In some illustrative examples, prior to positioning movable carriage 202, one end of material sheet 204 is initially wrapped around longitudinal component 206. In some illustrative examples, prior to guiding material sheet 204 around longitudinal component 206 using side wheels 222 and top wheels 220 of movable carriage 202, an end of material sheet 204 is wrapped and taped to longitudinal component 206. In some illustrative examples, side wheels 222 and top wheels 220 engage material sheet 204 after an end of material sheet 204 is initially lifted and secured by another method.

As movable carriage 202 moves along longitudinal axis 272 of longitudinal component 206, side wheels 222 and top wheels 220 contact material sheet 204 to grip and guide material sheet 204. Side wheels 222 and top wheels 220 urge material sheet 204 up and around sides 264 and top 266 of cross-sectional shape 262 of longitudinal component 206. Contact of side wheels 222 against material sheet 204 on portion 207 of longitudinal component 206 guides material sheet 204 onto longitudinal component 206. Side wheels 222 and the top wheels 220 are facing into operating volume 216.

Material sheet 204 is lifted by breaking the contact between material sheet 204 and any support surface. In some illustrative examples, side wheels 222 and top wheels 220 are formed of a material having a coefficient of friction with material sheet 204 sufficient to guide material sheet 204 around longitudinal component 206. In some illustrative examples, side wheels 222 are formed of material 233 having coefficient of friction 235 with material sheet 204 sufficient to guide material sheet 204 around longitudinal component 206. In some illustrative examples, top wheels 220 are formed of material 225 having coefficient of friction 227 with material sheet 204 sufficient to guide material sheet 204 around longitudinal component 206.

Different levels of force can be applied by at least one of side wheels 222 or top wheels 220 to material sheet 204 depending upon the type of material of material sheet 204. For a lower friction material, less force can be applied. If the friction between a respective wheel material and material sheet 204 is much larger than the friction between material sheet 204 and the exposed surface of longitudinal component 206, less force can be applied. If the difference in coefficients of friction between material sheet 204 and the wrap surface of longitudinal component 206 and material sheet 204 and a respective wheel material is small, normal force can be increased to amplify the wrapping power of the wheels.

In some illustrative examples, at least one of top wheels 220 or side wheels 222 are spring-loaded and clamping force can be applied by springs. For a higher friction material, greater clamping force can be applied by providing one or more springs. In some illustrative examples, the spring is positioned between a respective wheel of plurality of wheels 201 and a respective positioning plate of number of positioning plates 247. For a higher friction material, greater clamping force can be applied by increasing the loading of a respective spring or springs. More friction by the wheels can be applied by increasing the normal force or by modifying the material of the wheels itself.

Friction forces can be created or increased due to rotation of plurality of wheels 201. Friction forces can be created or increased due to dragging of plurality of wheels 201 in direction of movement of movable carriage 202. Friction forces can be created or increased due to movement of material sheet 204. In some illustrative examples, movement of movable carriage 202 provides friction forces through passive movement of at least one wheel of plurality of wheels 201. In some illustrative examples, movement of movable carriage 202 provides friction forces through actively driven rotation of at least one wheel of plurality of wheels 201. In some illustrative examples, movement of the movable carriage provides friction forces through dragging of at least one wheel of plurality of wheels 201.

Material sheet 204 has two surfaces, first surface 283 and second surface 285. Prior to wrapping material sheet 204 around longitudinal component 206, first surface 283 faces longitudinal component 206. When material sheet 204 is wrapped around longitudinal component 206, at least a portion of first surface 283 is in contact with longitudinal component 206. Prior to wrapping material sheet 204 around longitudinal component 206, second surface 285 faces away from longitudinal component 206. In some illustrative examples, first surface 283 can be referred to as an inner surface. In some illustrative examples, second surface 285 can be referred to as an outer surface.

Top wheels 220 or side wheels 222 contact second surface 285 while guiding material sheet 204. In some illustrative examples, first surface 283 and second surface 285 have different textures from each other. In some illustrative examples, a difference in textures can influence how strongly top wheels 220 or side wheels 222 urge material sheet 204 against longitudinal component 206. In some illustrative examples, first surface 283 can have an attractive or adhesive effect. In some illustrative examples, if first surface 283 is at least partially attracted to or adhered to longitudinal component 206, top wheels 220 or side wheels 222 may use less force to urge material sheet 204.

In some illustrative examples, at least one of top wheels 220 or side wheels 222 are spring loaded. In some illustrative examples, movable carriage 202 comprises springs 244 arranged in spring pairs, wherein each spring pair of spring pairs is connected to a respective wheel of one of top wheels 220 or side wheels 222. In some illustrative examples, movable carriage 202 comprises springs 244 arranged in spring pairs 246, wherein each spring pair of spring pairs 246 is connected to a respective wheel of side wheels 222. In some illustrative examples, movable carriage 202 comprises springs 250 arranged in spring pairs 252, wherein each spring pair of spring pairs 252 is connected to a respective wheel of top wheels 220. When present, springs 244 and springs 250 provide compliance for movable carriage 202.

Spring pairs 246 have number of stiffnesses 248. In some illustrative examples, at least one spring pair of spring pairs 246 has the same stiffness in both springs in the spring pair. In some illustrative examples, each spring pair has two different stiffnesses in the pair. In some illustrative examples, number of stiffnesses 248 is selected to provide urging of material sheet 204. Number of stiffnesses 248 is selected to modify intensity of urging of material sheet 204.

Springs 250 can be used to apply pressure to material sheet 204. In some illustrative examples, pressure applied by springs 250 aids in gripping and lifting material sheet 204. Any desirable quantity of springs 250 can be attached to each of side wheels 222. In some illustrative examples, springs 250 are arranged in spring pairs 252. In some illustrative examples, side wheels 222 are connected to sides 214 of frame 208 by spring pairs 252.

Spring pairs 252 have number of stiffnesses 254. In some illustrative examples, at least one spring pair of spring pairs 252 has the same stiffness in both springs in the spring pair. In some illustrative examples, each spring pair has two different stiffnesses. In some illustrative examples, number of stiffnesses 254 is selected to provide urging of material sheet 204.

In some illustrative examples, at least one spring pair of spring pairs 246 or spring pairs 252 has a stiffer spring towards the front of movable carriage 202. In these illustrative examples, the spring in at least one spring pair of at least one of spring pairs 246 or spring pairs 252 is stiffer in the direction of movement.

A difference in force putting the normal force at an angle aids in moving material sheet 204 into place. When number of stiffnesses 254 has more than one stiffness, the spring pair can put the normal force at an angle. In some illustrative examples, a design of movable carriage 202 allows for an external force to apply the normal force at an angle. In some illustrative examples, frame 208 is flexible or jointed in select locations to allow a force external to frame 208 to be imparted on movable carriage 202. Imparting a force external to frame 208 can apply the normal force at an angle.

In some illustrative examples, movable carriage 202 comprises side positioning plates 240 connecting side wheels 222 to sides 214 of frame 208 at angles 242 configured to engage sides 264 of longitudinal component 206. In these illustrative examples, side positioning plates 240 are positioning plates of number of positioning plates 247. In some illustrative examples, side positioning plates 240 are present for side wheels 222 to engage sides 264 of trapezoidal 268 cross-sectional shape 262 of longitudinal component 206. Side positioning plates 240 are adjustable. Side positioning plates 240 enable an adjustable normal force which correlates with an adjustable net wrapping force to wrap material sheet 204 based on coefficient of friction 235.

In some illustrative examples, movable carriage 202 comprises top positioning plates 249 connecting top wheels 220 to frame 208. In these illustrative examples, top positioning plates 249 are ones of number of positioning plates 247 connected to top wheels 220. In these illustrative examples, top positioning plates 249 place top wheels 220 normal to cross-sectional shape 262 of longitudinal component 206.

Side wheels 222 are arranged in a series of stages. First stage 243 of side wheels 222 encounters a portion of material sheet 204 first. First stage 243 of side wheels 222 provides lift to material sheet 204. Subsequent stages of wheels of side wheels 222 more aggressively pull material sheet 204 tighter around longitudinal component 206. For example, second stage 245 of side wheels 222 encounters a portion of material sheet 204 after first stage 243. A number of respective angles of side wheels 222 in first stage 243 are smaller in magnitude than a number of respective angles of side wheels 222 in second stage 245. Magnitudes of respective angles of side wheels 222 can be increased per stage in the progressive stages.

In some illustrative examples, each stage of side wheels 222 can comprise a respective pair of side wheels. In some illustrative examples, each respective pair of side wheels 222 has a same angle relative to longitudinal component 206 to cause movable carriage 202 to be symmetrical 218. In other illustrative examples, wheels of a respective pair of side wheels 222 can have different angles relative to longitudinal component 206.

In some illustrative examples, each pair of side wheels 222 has a respective position along center plane 210 such that movable carriage 202 is symmetrical 218. In some illustrative examples, wheels of a respective pair of side wheels 222 can be offset from each other along center plane 210.

In some illustrative examples, side wheels 222 comprise first side wheel pair 232 positioned at third angle 234. In some illustrative examples, side wheels 222 comprise second side wheel pair 236 positioned at fourth angle 238. In some illustrative examples, fourth angle 238 is greater than third angle 234.

Third angle 234 and fourth angle 238 can be measured relative to a manufacturing floor. Third angle 234 and fourth angle 238 can be measured relative to a longitudinal direction of longitudinal component 206.

In some illustrative examples, top wheels 220 comprise first top wheel pair 224 positioned at first angle 226 relative to center plane 210. In some illustrative examples, top wheels 220 comprise second top wheel pair 228 positioned at second angle 230 relative to center plane 210. In some illustrative examples, second angle 230 is greater than first angle 226.

In some illustrative examples, first angle 226 is approximately 15 degrees and second angle 230 is approximately 30 degrees. In some illustrative examples, side wheels 222 are connected to sides 214 of frame 208 and top wheels 220 are connected to top 212 of frame 208.

In some illustrative examples, first angle 226 and second angle 230 can be selected from a range of 0 degrees to 30 degrees. In some illustrative examples, first angle 226 and second angle 230 can be selected from a range of 0 degrees to 45 degrees. In some illustrative examples, first angle 226 and second angle 230 can be selected from a range of 0 degrees to 60 degrees. In some illustrative examples, first angle 226 and second angle 230 can be selected from a range of 15 degrees to 30 degrees.

In some illustrative examples, third angle 234 and fourth angle 238 can be selected from a range of 0 degrees to 30 degrees. In some illustrative examples, third angle 234 and fourth angle 238 can be selected from a range of 0 degrees to 45 degrees. In some illustrative examples, third angle 234 and fourth angle 238 can be selected from a range of 0 degrees to 60 degrees. In some illustrative examples, third angle 234 and fourth angle 238 can be selected from a range of 15 degrees to 30 degrees. Third angle 234 is selected to provide a first initial lift of material sheet 204. Increasing third angle 234 can more aggressively pull material from a flat orientation to curve around longitudinal component 206. In some illustrative examples, having an overly large third angle 234 can cause inconsistencies such as wrinkles. Fourth angle 238 is greater than third angle 234 to pull material sheet 204 tighter towards the back of movable carriage 202.

In some illustrative example, movable carriage 202 comprises movement system 256. Movement system 256 is connected to frame 208 and configured to move movable carriage 202 in a direction parallel to center plane 210. In some illustrative examples, movement system 256 is at least partially powered. In some illustrative examples, movement system 256 comprises motor 260 configured to at least partially drive movable carriage 202 parallel to center plane 210. In some illustrative examples, movement system 256 is manually operated.

In some illustrative examples, movement system 256 comprises wheels 258 configured to travel on a track system 286. In some illustrative examples, movement system 256 comprises linear sliders configured to travel on a track system 286. A position of movable carriage 202 relative to a center of longitudinal component 206 can be controlled using movement system 256. Movement system 256 can be used to keep components of movable carriage 202 symmetric about longitudinal component 206. In some illustrative examples, movable carriage 202 is hand-held. In some illustrative examples, movement system 256 is configured to control position of movable carriage 202 relative to longitudinal component 206.

In some illustrative examples, movable carriage 202 comprises frame 208 with center plane 210, top 212, and sides 214, movement system 256 connected to sides 214 of frame 208, side wheels 222 connected to frame 208, and top wheels 220 connected to frame 208. Movement system 256 is configured to move movable carriage 202 in a movement direction parallel to center plane 210. Side wheels 222 comprise a first side wheel pair 232 symmetric about center plane 210, and second side wheel pair 236 symmetric about center plane 210 and offset from first side wheel pair 232 along center plane 210.

In some illustrative examples, top wheels 220 are arranged in a series of stages. In some illustrative examples, first stage 243 of top wheels 220 encounters a portion of material sheet 204 first. First stage 243 of top wheels 220 provides lift to material sheet 204. Subsequent stages of wheels of top wheels 220 more aggressively pull material sheet 204 tighter around longitudinal component 206. For example, second stage 245 of top wheels 220 encounters a portion of material sheet 204 after first stage 243. A number of respective angles of top wheels 220 in first stage 243 are smaller in magnitude than a number of respective angles of top wheels 220 in second stage 245. Magnitudes of respective angles of top wheels 220 can be increased per stage in the progressive stages.

In some illustrative examples, each stage of top wheels 220 can comprise a respective pair of top wheels. In some illustrative examples, each respective pair of top wheels 220 has a same angle relative to longitudinal component 206 to cause movable carriage 202 to be symmetrical 218. In other illustrative examples, wheels of a respective pair of top wheels 220 can have different angles relative to longitudinal component 206.

In some illustrative examples, each pair of top wheels 220 has a respective position along center plane 210 such that movable carriage is symmetrical 218. In some illustrative examples, wheels of a respective pair of top wheels 220 can be offset from each other along center plane 210.

Top wheels 220 comprise first top wheel pair 224 symmetric about center plane 210 and angled away from each other at first angle 226 and second top wheel pair 228 symmetric about the center plane 210 and angled away from each other at second angle 230.

In some illustrative examples, second angle 230 of second top wheel pair 228 is greater than first angle 226 of first top wheel pair 224. In some illustrative examples, second angle 230 of second top wheel pair 228 is approximately 30 degrees and first angle 226 of first top wheel pair 224 is approximately 15 degrees.

Longitudinal component 206 takes the form of any desirable component that has a substantially greater length than other measurements. In some illustrative examples, longitudinal component 206 is a part or product that is being manufactured. In some illustrative examples, longitudinal component 206 is a tool or other manufacturing apparatus for the manufacture of a part or product. In some illustrative examples, longitudinal component 206 takes the form of inflatable bladder 274.

Longitudinal component 206 has cross-sectional shape 262. Cross-sectional shape 262 is a shape perpendicular to longitudinal axis 272. Cross-sectional shape 262 has any desirable shape. In some illustrative examples, cross-sectional shape 262 is trapezoidal 268. In some illustrative examples, cross-sectional shape 262 is trapezoidal 268 with convex or bulbous edges. Longitudinal component 206 takes any desirable shape and is not limited to quadrilaterals.

To wrap material sheet 204 around longitudinal component 206, longitudinal component 206 is substantially rigid 276. When longitudinal component 206 is substantially rigid 276, longitudinal component 206 can provide reaction forces sufficient to counteract normal forces from plurality of wheels 201. In some illustrative examples, longitudinal component 206 is substantially rigid 276 for wrapping without additional processing or steps. In some illustrative examples, longitudinal component 206 is hollow or flexible and additional steps are taken to make portion 207 substantially rigid 276 to wrap material sheet 204 around portion 207 of longitudinal component 206.

In some illustrative examples, when longitudinal component 206 takes the form of inflatable bladder 274, inflatable bladder 274 is one of inflated 278 or filled 280 to make inflatable bladder 274 substantially rigid 276. Inflatable bladder 274 can be filled 280 with any desirable type of solid or fluid material. In some illustrative examples, inflatable bladder 274 can be filled 280 with a loose material or a solid shape.

Material sheet 204 takes the form of any desirable material for one of manufacturing or providing desired surface characteristics for a product. In some illustrative examples, material sheet 204 is a material wrapped around tooling or other manufacturing components. In some illustrative examples, material sheet 204 is wrapped around a product to provide a desired property or functionality. In some illustrative examples, material sheet 204 comprises one of a release film, a breather, or any other desirable type of film.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although only one material sheet, material sheet 204 is depicted, any desirable quantity of material sheets can be wrapped around longitudinal component 206 using movable carriage 202. In some illustrative examples, multiple material sheets are wrapped in multiple passes of movable carriage 202 along longitudinal axis 272 of longitudinal component 206.

In some illustrative examples, although only one movable carriage, movable carriage 202 is depicted, multiple carriages can be linked together to provide wrapping of multiple material sheets in one pass. In some illustrative examples, multiple movable carriages with a same design can be used to wrap multiple material sheets substantially simultaneously.

As another example, although only two stages, first stage 243 and second stage 245 of side wheels 222 are depicted, any desirable quantity of stages can be provided for side wheels 222. In some illustrative examples, more than two stages of wheels are provided for side wheels 222.

Additionally, although side wheels 222 and top wheels 220 are depicted as each having two stages, in some illustrative examples, side wheels 222 and top wheels 220 have different quantities of stages. In some illustrative examples, side wheels 222 have more stages than top wheels 220. In some illustrative examples, top wheels 220 have more stages than side wheels 222.

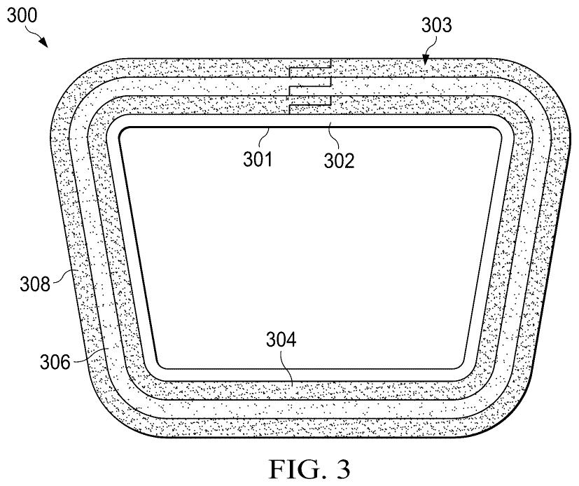

Turning now to FIG. 3, an illustration of a cross-sectional view of a longitudinal component with plurality of material sheets 303 is depicted in accordance with an illustrative embodiment. In view 300 a plurality of material sheets have been wrapped around longitudinal component 301. In this illustrative example, longitudinal component 301 takes the form of inflatable bladder 302. Inflatable bladder 302 is hollow. To apply plurality of material sheets 303 to inflatable bladder 302, inflatable bladder 302 is placed into a substantially rigid state. Inflatable bladder 302 can be placed into a substantially rigid state using any desirable method. In some illustrative examples, inflatable bladder 302 can be placed into a substantially rigid state by pressuring inflatable bladder 302 or by inserting a sufficiently rigid material into inflatable bladder 302.

Plurality of material sheets 303 can comprise any desirable type of material sheets. In some illustrative examples, plurality of material sheets 303 comprises at least one of a release film, a breather, or any other desirable type of film. In some illustrative examples, each of plurality of material sheets 303 is wrapped around longitudinal component 301 sequentially. In some illustrative examples, each of plurality of material sheets 303 is wrapped sequentially by a single movable carriage. In this example, material sheet 304 is wrapped around longitudinal component 301 by the movable carriage, and then movable carriage is reset and used to wrap material sheet 306 followed by material sheet 308.

In some illustrative examples, plurality of material sheets 303 can be wrapped around longitudinal component 301 concurrently. In some illustrative examples, plurality of material sheets 303 are wrapped around longitudinal component 301 by a series of movable carriages moving along longitudinal component 301 at the same time. In these illustrative examples, plurality of material sheets 303 are wrapped around longitudinal component 301 substantially simultaneously with a second wrap starting before the first wrap is finished.

Each of material sheet 304, material sheet 306, and material sheet 308 is schematically shown in FIG. 3 to have an overlap. Each overlap is a small portion of the respective material sheet that is on top of and in contact with itself. In other illustrative examples, at least one of material sheet 304, material sheet 306, and material sheet 308 can have abutting edges with itself, such as to create a seam. In these illustrative examples, at least one of material sheet 304, material sheet 306, and material sheet 308 may not have an overlap. In FIG. 3, the overlap is illustrated as occurring in the same position relative to longitudinal component 301 for each of the plurality of material sheets 303 wrapped around longitudinal component 301. However, this is not required to all embodiments, as the position of overlaps or seams for the material layers may vary with respect to each other, such as depending on the initial alignment or position of each material sheet with the longitudinal component.

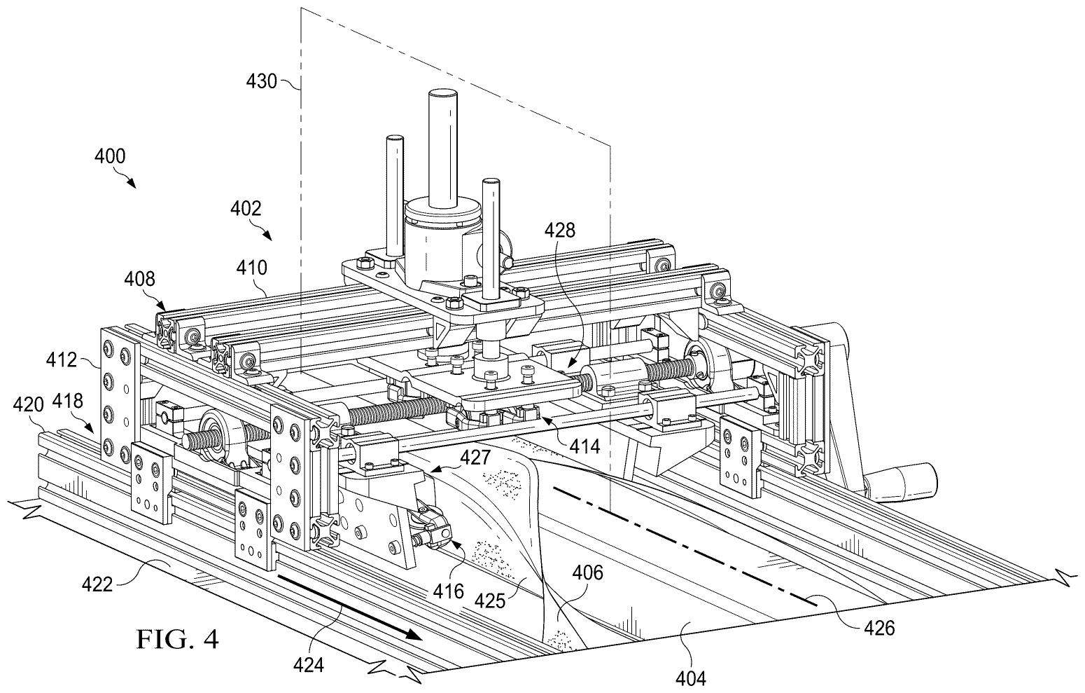

Turning now to FIG. 4, an illustration of an isometric view of a movable carriage applying a material sheet around a longitudinal component is depicted in accordance with an illustrative embodiment. In view 400, movable carriage 402 is moving along longitudinal component 404 to wrap material sheet 406 around longitudinal component 404. Movable carriage 402 is a physical implementation of movable carriage 202 of FIG. 2. Movable carriage 402 can be used to wrap at least one material sheet of plurality of material sheets 303 of FIG. 3.

Movable carriage 402 is configured to wrap material sheet 406 around longitudinal component 404 placed on material sheet 406. Movable carriage 402 comprises frame 408 defining center plane 430 and operating volume 428, side wheels 416 within operating volume 428, and top wheels 414 within operating volume 428. In this illustrative example, side wheels 416 are connected to sides 412 of frame 408 and top wheels 414 are connected to top 410 of frame 408.

Side wheels 416 are configured to guide material sheet 406 against sides 425 of portion 427 of longitudinal component 404, when disposed within operating volume 428 and aligned with center plane 430, as movable carriage 402 moves parallel to center plane 430. As depicted, longitudinal axis 426 of longitudinal component 404 is aligned with center plane 430 defined by movable carriage 402. Side wheels 416 are arranged as one or more opposing pairs about center plane 430. In this illustrative example, side wheels 416 are spring loaded.

Portion 427 of longitudinal component 404 is located in proximity to movable carriage 402 such that material sheet 406 adjacent to portion 427 is acted upon by movable carriage 402. In some illustrative examples, portion 427 is located within operating volume 428. In some illustrative examples, movement of movable carriage 402 causes lifting of material sheet 406 outside of operating volume 428.

Top wheels 414 within operating volume 428 are configured to guide the material sheet 406 against the top of portion 427 of longitudinal component 404 as movable carriage 402 moves parallel to center plane 430.

In some illustrative examples, top wheels 414 are arranged as one or more opposing pairs about center plane 430. Side wheels 416 and top wheels 414 are facing into operating volume 428.

In this illustrative example, movable carriage 402 comprises movement system 418 connected to frame 408 and configured to move movable carriage 402 in direction 424 parallel to center plane 430. In some illustrative examples, movement system 418 comprises wheels configured to travel on track system 420. In some illustrative examples, movement system 418 comprises a bearing system configured to interact with track system 420.

Movable carriage 402 is configured to wrap material sheet 406 around longitudinal component 404. In this illustrative example, movable carriage 402 comprises frame 408 with center plane 430, top 410, and sides 412; movement system connected to sides 412 of the frame, side wheels 416 connected to frame 408, and top wheels 414 connected to frame 408. Movable carriage 402 further comprises movement system 418 configured to move movable carriage 402 in direction 424 parallel to center plane 430.

In view 400, material sheet 406 is being wrapped around longitudinal component 404. Movable carriage 402 has been positioned such that longitudinal component 404 is within operating volume 428 beneath frame 408 of movable carriage 402.

Movable carriage 402 is being moved in direction 424 parallel to longitudinal axis 426 of longitudinal component 404. Material sheet 406 is guided around longitudinal component 404 using wheels of movable carriage 402 within operating volume 428 as movable carriage 402 moves in direction 424. In this illustrative example, moving movable carriage 402 comprises moving movable carriage 402 along track system 420 of work table 422 supporting longitudinal component 404.

In view 400, movable carriage 402 is guiding material sheet 406 around longitudinal component 404 using top wheels 414 and side wheels 416. Movable carriage 402 is guiding material sheet 406 onto sides 425 of portion 427 of longitudinal component 404 using side wheels 416 connected to sides 412 of frame 408 and arranged as opposing pairs about center plane 430 defined by frame 408.

Side wheels 416 and top wheels 414 are passively driven by moving movable carriage 402 in direction 424. Wrapping material sheet 406 around longitudinal component 404 is performed by movement of side wheels 416 and top wheels 414. Wrapping material sheet 406 is performed due to the angles of side wheels 416 and top wheels 414 relative to direction 424 of movement. In this illustrative example, guiding material sheet 406 around longitudinal component 404 comprises passively driving the wheels by moving movable carriage 402 in direction 424.

In some illustrative examples, movement system 418 comprises a motor configured to at least partially drive movable carriage 402 parallel to center plane 430. In some illustrative examples, moving movable carriage 402 comprises at least partially powering movement of movable carriage 402 using a motor.

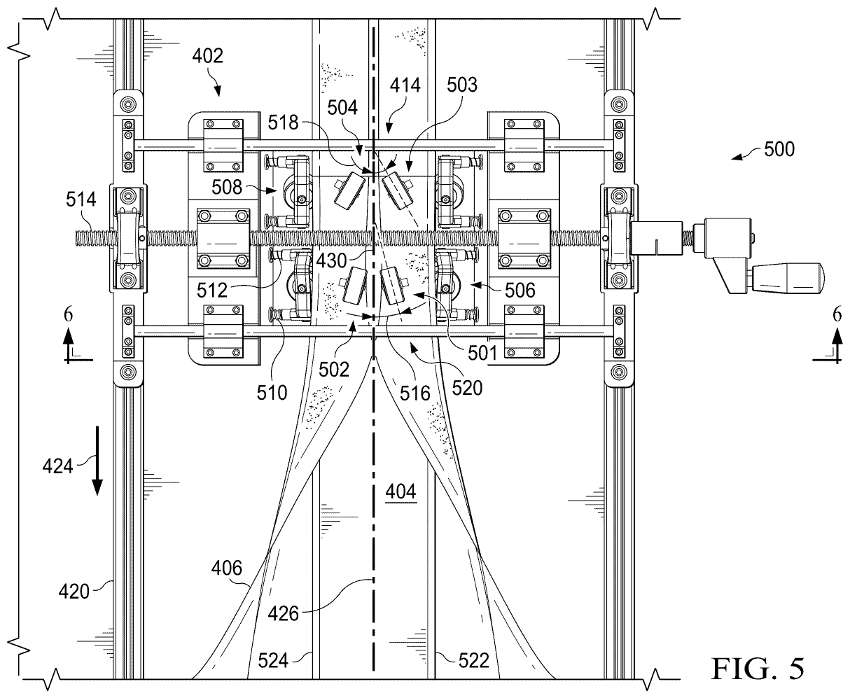

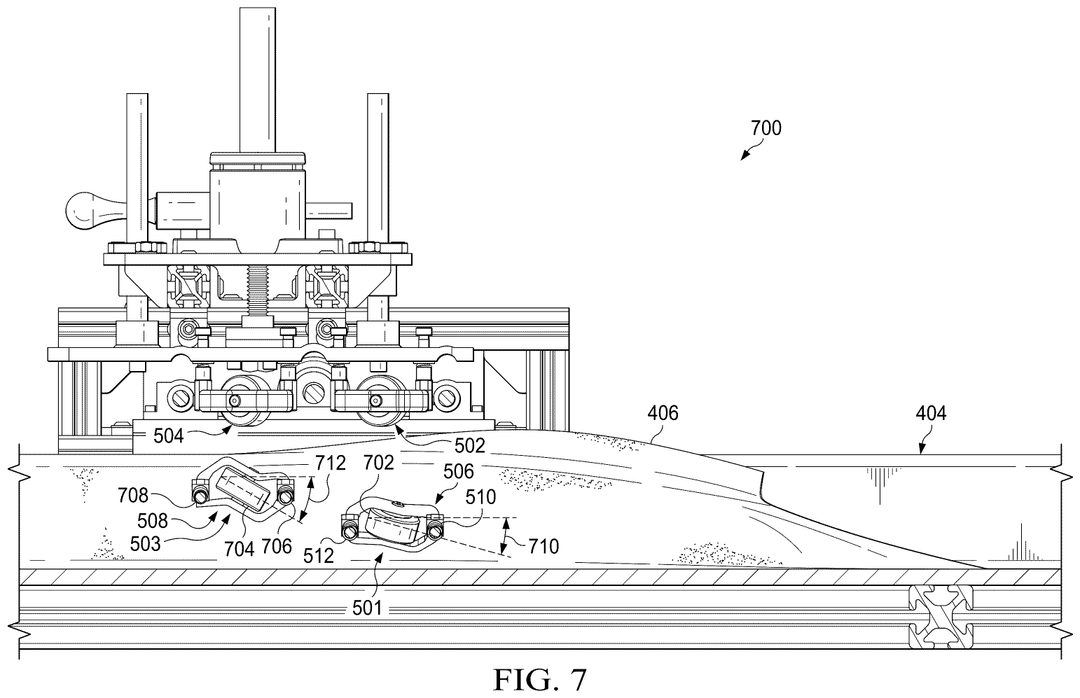

Turning now to FIG. 5, an illustration of a top view of a movable carriage applying a material sheet around a longitudinal component is depicted in accordance with an illustrative embodiment. In view 500, top wheels 414 are visible. FIGS. 5 and 7 demonstrate position of the wheels of movable carriage 402 relative to surface planes of longitudinal component 404.

Top wheels 414 are arranged in a series of stages. Each stage of the series of stages progressively increases an angle of the respective wheels. Increasing the angle of each respective stage progressively moves material sheet 406 towards longitudinal component 404. In this illustrative example, top wheels 414 are arranged in two stages: first stage 501 comprising first top wheel pair 502 and second stage 503 comprising second top wheel pair 504. As depicted, the angle of the wheels in second stage 503 of top wheels 414 is greater than the angle of the wheels in first stage 501 of top wheels 414. Although first stage 501 is symmetric and second stage 503 is symmetric, in some illustrative examples, at least one of first stage 501 or second stage 503 can be asymmetric.

First stage 501 further comprises first side wheel pair 506. First top wheel pair 502 and first side wheel pair 506 are positioned at a same location along center plane 430. Second stage 503 further comprises second side wheel pair 508. Second top wheel pair 504 and second side wheel pair 508 are positioned at a same location along center plane 430.

Top wheels 414 comprise first top wheel pair 502 symmetric about center plane 430 and angled away from each other at first angle 516, and second top wheel pair 504 symmetric about center plane 430 and angled away from each other at second angle 518. In this illustrative example, top wheels 414 comprise first top wheel pair 502 positioned at first angle 516 relative to center plane 430. In this illustrative example, top wheels 414 comprise second top wheel pair 504 positioned at second angle 518 relative to center plane 430. In this illustrative example, second angle 518 is greater than first angle 516. As depicted, first angle 516 is approximately 15 degrees and second angle 518 is approximately 30 degrees.

Side wheels 416 comprise first side wheel pair 506 symmetric about center plane 430 and second side wheel pair 508 symmetric about center plane 430 and offset from first side wheel pair 506 along center plane 430. First side wheel pair 506 is located forward of second side wheel pair 508 in direction 424. First top wheel pair 502 is located forward of second top wheel pair 504 in direction 424.

In this illustrative example, guiding material sheet 406 around longitudinal component 404 using wheels of movable carriage 402 within the operating volume 428 as movable carriage 402 moves in direction 424 comprises sequentially contacting material sheet 406 with opposing pairs of wheels at increasing angles relative to direction 424. In this illustrative example, guiding material sheet 406 onto top 520 of longitudinal component 404 uses top wheels 414 connected to top 410 of the frame 408 and arranged as opposing pairs about center plane 430.

In this illustrative example, side wheels 416 are spring loaded. In this illustrative example, side wheels 416 are connected to sides 412 of frame 408 by spring pairs. In this illustrative example, the springs are arranged in spring pairs, wherein each spring pair of the spring pairs is connected to a respective wheel of one of top wheels 414 or side wheels 416. In some illustrative examples, each spring pair has two different stiffnesses. An example of a spring pair is spring 510 and spring 512. In some illustrative examples, spring 510 and spring 512 have two different stiffnesses. The force provided by the springs applies a normal force to side 522 and side 524 of longitudinal component 404.

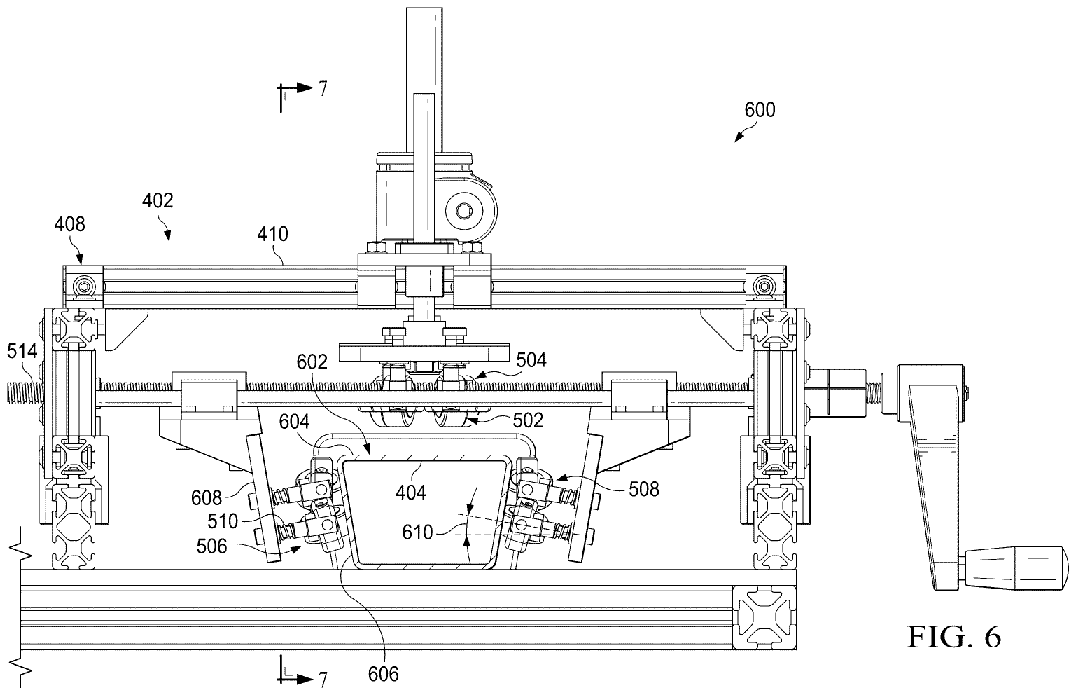

Turning now to FIG. 6, an illustration of a front cross-sectional view of a movable carriage applying a material sheet around a longitudinal component is depicted in accordance with an illustrative embodiment. FIG. 6 demonstrates position of the wheels of movable carriage 402 relative to a cross-section of longitudinal component 404. Longitudinal component 404 has cross-sectional shape 602 with top 604 and sides 606. In this illustrative example, cross-sectional shape 602 is trapezoidal. In this illustrative example, movable carriage 402 comprises side positioning plates 608. Side positioning plates 608 connect side wheels 416 to sides of frame 408 at angle 610 configured to engage sides 606 of longitudinal component 404. Angle 610 is the same in the longitudinal direction of longitudinal component 404.

Turning now to FIG. 7, an illustration of a side view of a movable carriage applying a material sheet around a longitudinal component is depicted in accordance with an illustrative embodiment. In view 700, side wheels 416 are visible.

Side wheels 416 are arranged in a series of stages. Each stage of the series of stages progressively increases an angle of the respective wheels. Increasing the angle of each respective stage progressively moves material sheet 406 towards longitudinal component 404. In this illustrative example, side wheels 416 comprises two stages: first stage 501 comprising first side wheel pair 506 and second stage 503 comprising second side wheel pair 508. As depicted, the angle of the wheels in second stage 503 of top wheels 414 is greater than the angle of the wheels in first stage 501 of top wheels 414. Although first stage 501 is symmetric and second stage 503 is symmetric, in some illustrative examples, at least one of first stage 501 or second stage 503 can be asymmetric.

In view 700 side wheel 702 of first side wheel pair 506 and side wheel 704 of second side wheel pair 508 are visible. Spring 510 and spring 512 are connected to side wheel 702. Spring 706 and spring 708 are connected to side wheel 704. In some illustrative examples, the stiffnesses of spring 510 and spring 512 are the same. In some illustrative examples, the stiffness of spring 510 is greater than the stiffness of spring 512.

In some illustrative examples, the stiffnesses of spring 706 and spring 708 are the same. In some illustrative examples, the stiffness of spring 706 is greater than the stiffness of spring 708. In some illustrative examples, the front springs, spring 510 and spring 706 have the same stiffness greater than the stiffness of spring 512 and spring 708.

First side wheel pair 506 is positioned at third angle 710. Second side wheel pair 508 is positioned at fourth angle 712. Fourth angle 712 is greater than third angle 710. As depicted, third angle 710 is approximately 15 degrees. As depicted, fourth angle 712 is approximately 30 degrees. Third angle 710 and fourth angle 712 are angles in the longitudinal direction of longitudinal component 404.

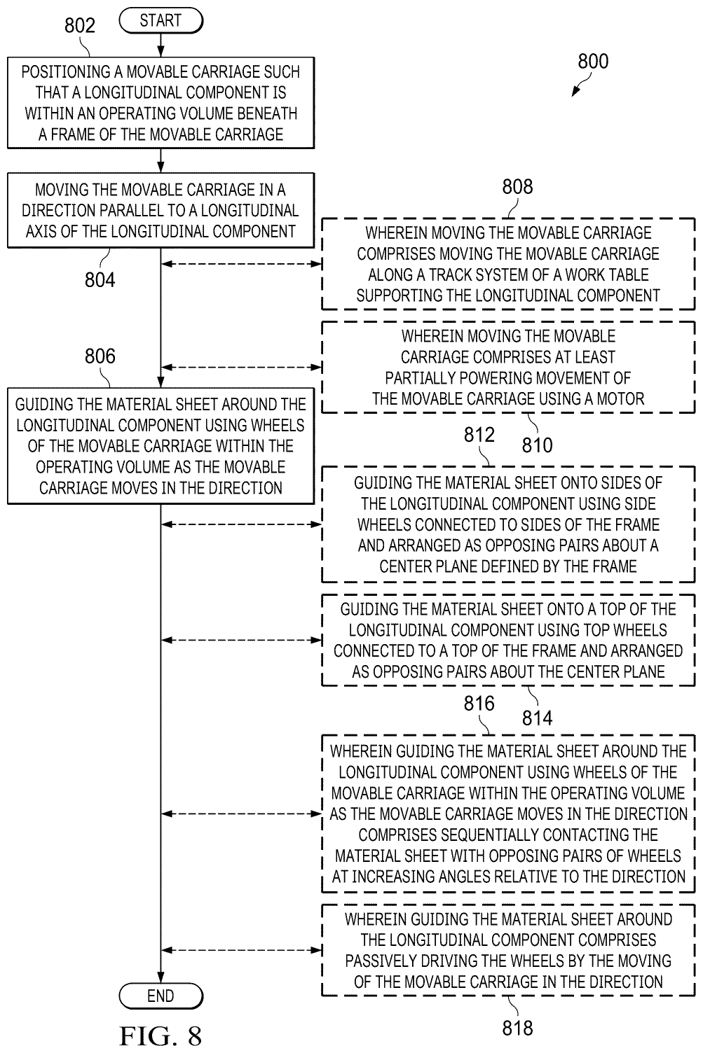

Turning now to FIG. 8, a flowchart of a method of wrapping a material sheet around a longitudinal component is depicted in accordance with an illustrative embodiment. Method 800 can be implemented in manufacturing a component of aircraft 100 of FIG. 1. Method 800 can be performed using movable carriage 202 of FIG. 2. Method 800 can be performed to wrap at least one material sheet of plurality of material sheets 303 on longitudinal component 301 of FIG. 3. Method 800 can be performed using movable carriage 402 of FIGS. 4-7.

Method 800 positions a movable carriage such that a longitudinal component is within an operating volume beneath a frame of the movable carriage (operation 802). Method 800 moves the movable carriage in a direction parallel to a longitudinal axis of the longitudinal component (operation 804). Method 800 guides the material sheet around the longitudinal component using wheels of the movable carriage within the operating volume as the movable carriage moves in the direction (operation 806). Afterwards, method 800 terminates.

In some illustrative examples, moving the movable carriage comprises moving the movable carriage along a track system of a work table supporting the longitudinal component (operation 808). In some illustrative examples, the track system can align movement of the movable carriage with a longitudinal axis of the longitudinal component. In some illustrative examples, moving the movable carriage comprises at least partially powering movement of the movable carriage using a motor (operation 810). In some illustrative examples, a motor fully powers the movement of the movable carriage. In some illustrative examples, a motor reduces the force provided by an operator to move the movable carriage.

In some illustrative examples, guiding the material sheet around the longitudinal component using the wheels comprises guiding the material sheet onto sides of the longitudinal component using side wheels connected to sides of the frame and arranged as one or more opposing pairs about a center plane defined by the frame (operation 812). In some illustrative examples, guiding the material sheet around the longitudinal component using the wheels comprises guiding the material sheet onto a top of the longitudinal component using top wheels connected to a top of the frame and arranged as one or more opposing pairs about the center plane (operation 814).

In some illustrative examples, guiding the material sheet around the longitudinal component using wheels of the movable carriage within the operating volume as the movable carriage moves in the direction comprises sequentially contacting the material sheet with one or more opposing pairs of wheels at increasing angles relative to the direction (operation 816). In some illustrative examples, guiding the material sheet around the longitudinal component comprises passively driving the wheels by the moving of the movable carriage in the direction (operation 818).

In some illustrative examples, prior to positioning the movable carriage, one end of the material sheet is initially wrapped around the longitudinal component. In some illustrative examples, prior to guiding the material sheet around the longitudinal component using the wheels of the movable carriage, an end of the material sheet is wrapped and taped to the longitudinal component. In some illustrative examples, the wheels engage the material sheet after an end of the material sheet is initially lifted by another method.

As used herein, the phrase “at least one of,” when used with a list of items, means different combinations of one or more of the listed items may be used and only one of each item in the list may be needed. For example, “at least one of item A, item B, or item C,” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 808 through operation 818 may be optional.

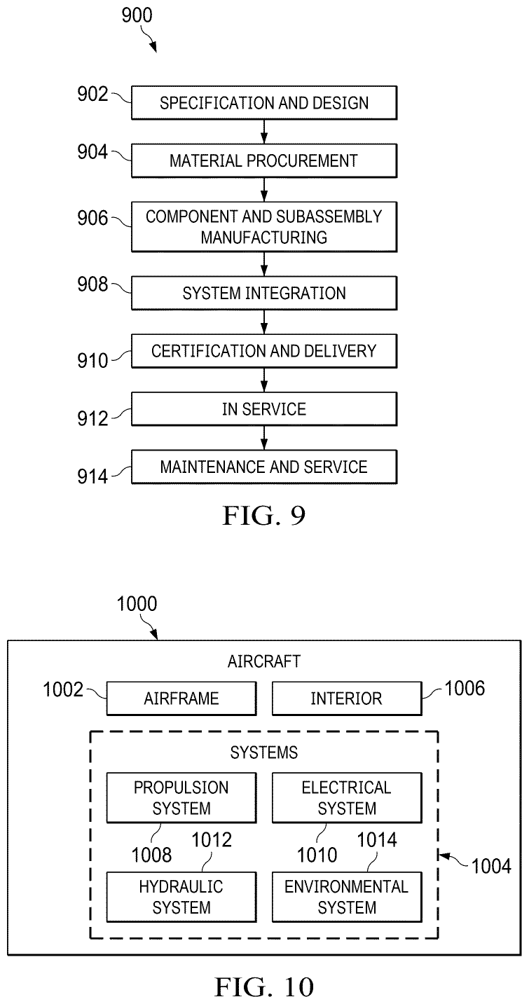

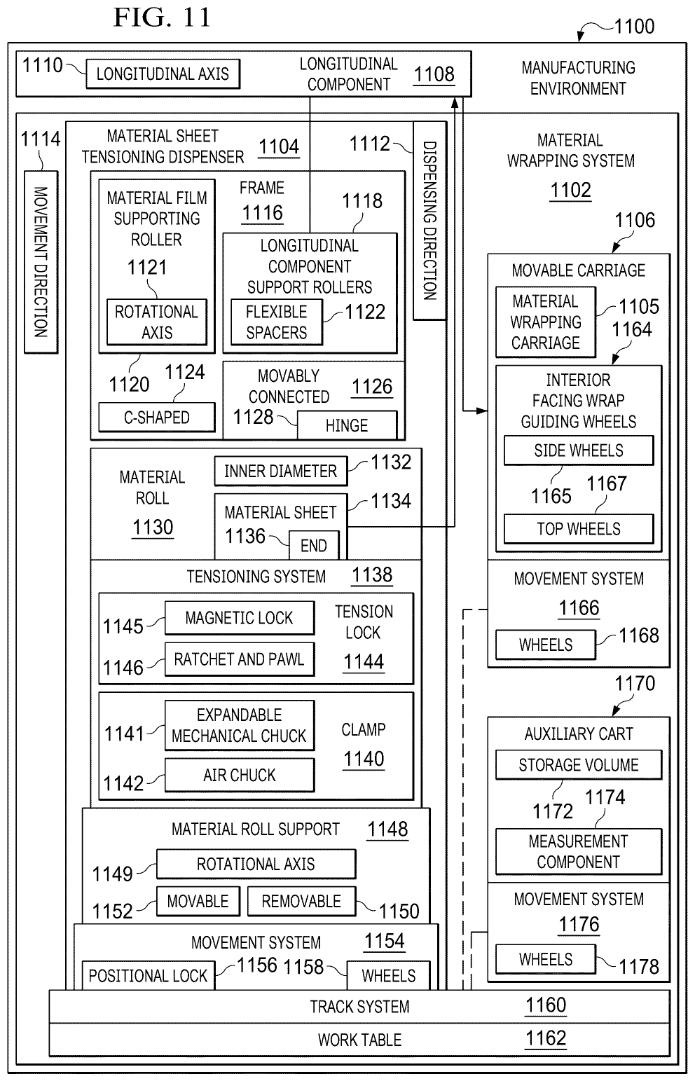

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in a form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of an aircraft in a form of a block diagram is depicted in which an illustrative embodiment may be implemented. In this example, aircraft 1000 is produced by aircraft manufacturing and service method 900 of FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included.

Apparatuses and methods embodied herein may be employed during at least one of the stages of aircraft manufacturing and service method 900. One or more illustrative embodiments may be manufactured or used during at least one of component and subassembly manufacturing 906, system integration 908, in service 912, or maintenance and service 914 of FIG. 9.

The illustrative examples present a movable carriage and methods for wrapping a material sheet around a longitudinal component. In some illustrative examples, the movable carriage can be referred to as a zipper mechanism. The movable carriage comprises angled wheels that pull up a material sheet to wrap around bladder. The wheels are sufficiently compliant to pull the material sheet. The movable carriage comprises a frame that houses the angled wheels that form the zipper mechanism. In some illustrative examples, the frame of the movable carriage provides adjustability in horizontal and vertical positioning of the wheels.

In some illustrative examples, the angled wheels passively roll as the movable carriage moves along the longitudinal component.

To wrap the material sheet around the longitudinal component, the movable carriage is moved along the length of the longitudinal component. The angled wheels are in contact with the material sheet as the movable carriage moves along the longitudinal.

The angled wheels guide and tighten the material into place as the angled wheels roll. Angles of the angled wheels can be adjusted based on the design of the longitudinal component, type of material sheet, and other characteristics.

In some illustrative examples, springs push the angled wheels against the surface of the longitudinal component. In these illustrative examples, the springs provide normal/friction forces to move the material sheet.

In some illustrative examples, the movable carriage features several opposed pairs of spring-biased wheels disposed at angles configured to frictionally guide and tighten a material sheet around and against the exterior surfaces of the longitudinal component, such as an inflatable bladder. In some illustrative examples, the movable carriage is adjustable to the longitudinal component. In some illustrative examples, right and left hand lead screw are provided for symmetric guides adjustment around the longitudinal component.

The movable carriage reduces the time to wrap the material sheet around the longitudinal component. The movable carriage can reduce the time to wrap the material sheet around the longitudinal component from multiple hours to less than an hour.

In some illustrative examples, the movable carriage can ride along an optional rail system. An optional rail system can guide the direction of movement of the movable carriage. In some illustrative examples, the movable carriage can be motorized on the rail. The optional rail system can have a length scaled for different sized longitudinal components.

The movable carriage can save manufacturing space in comparison to stationary systems. By moving movable carriage along the longitudinal component, the footprint for the wrapping system can be half the length of a stationary system. The movable carriage slides along the longitudinal component, saving space in comparison to sliding a longitudinal component through a system.

In some illustrative examples, a longitudinal component can be placed on a work table. In some illustrative examples, the longitudinal component is placed on a material sheet on the work table. In some illustrative examples, the longitudinal component can take the form of a bladder. The bladder is made substantially rigid prior to wrapping the material sheet around the longitudinal component. In some illustrative examples, the bladder is filled with air to cause the longitudinal component to be substantially rigid.

In some illustrative examples, the material sheet is loaded and fed to the movable carriage. The movable carriage is moved along the longitudinal component to fold the material sheet around the longitudinal component. The material sheet is taped to the longitudinal component and excess material sheet is cut off at the end of the longitudinal component. The wrapped longitudinal component is removed from the work table. In some illustrative examples, multiple carriages can be linked together to provide multiple layers of wrap in one pass.

An embodiment of the present disclosure provides a movable carriage configured to wrap a material sheet around a longitudinal component, for example when the longitudinal component is placed, disposed, or otherwise arranged on the material sheet. An embodiment of the present disclosure provides a movable carriage configured to wrap a material sheet around a longitudinal component placed on the material sheet. The movable carriage comprises a frame defining a center plane and an operating volume, side wheels within the operating volume configured to guide the material sheet against sides of a portion of the longitudinal component when disposed within the operating volume and aligned with the center plane, as the movable carriage moves parallel to the center plane, and top wheels within the operating volume configured to guide the material sheet against the top of the portion of the longitudinal component as the movable carriage moves parallel to the center plane. The side wheels are arranged as one or more opposing pairs about the center plane. The top wheels are arranged as one or more opposing pairs about the center plane.

Another embodiment of the present disclosure provides a movable carriage configured to wrap a material sheet around a longitudinal component. The movable carriage comprises a frame with a center plane, top, and sides; a movement system connected to the sides of the frame; side wheels connected to the frame, and top wheels connected to the frame. The movement system is configured to move the movement of the movable carriage in a movement direction parallel to the center plane. The side wheels comprise a first side wheel pair symmetric about the center plane, and a second side wheel pair symmetric about the center plane and offset from the first side wheel pair along the center plane. The top wheels comprise a first top wheel pair symmetric about the center plane and angled away from each other at a first angle, and a second top wheel pair symmetric about the center plane and angled away from each other at a second angle.

A further embodiment of the present disclosure provides a movable carriage configured to wrap a material sheet around a longitudinal component. The movable carriage comprises a frame defining a center plane and an operating volume; a plurality of wheels within the operating volume arranged as a plurality of stages offset from each other along the center plane of the frame, wherein angles of wheels of each respective stage of the plurality of stages increase along the center plane; and a number of positioning plates connected to the frame and holding the plurality of wheels normal to a cross-sectional shape of the longitudinal component.

Yet another embodiment of the present disclosure provides a method of wrapping a material sheet around a longitudinal component. A movable carriage is positioned such that a longitudinal component is within an operating volume beneath a frame of the movable carriage. The movable carriage is moved in a direction parallel to a longitudinal axis of the longitudinal component. The material sheet is guided around the longitudinal component using wheels of the movable carriage within the operating volume as the movable carriage moves in the direction.

Clause 1: A movable carriage configured to wrap a material sheet around a longitudinal component, the movable carriage comprising: a frame defining a center plane and an operating volume; side wheels within the operating volume configured to guide the material sheet against sides of a portion of the longitudinal component, when disposed within the operating volume and aligned with the center plane, as the movable carriage moves parallel to the center plane, the side wheels arranged as one or more opposing pairs about the center plane; and top wheels within the operating volume configured to guide the material sheet against a top of the portion of the longitudinal component as the movable carriage moves parallel to the center plane, the top wheels arranged as one or more opposing pairs about the center plane.

Clause 2: The movable carriage of clause 1, wherein at least one of the side wheels or the top wheels are configured to provide a normal force to a cross-sectional shape of the longitudinal component. Clause 3. The movable carriage of clause 1, wherein at least one of the side wheels or the top wheels are spring loaded.

Clause 4. The movable carriage of clause 1 further comprising: springs arranged in spring pairs, wherein each spring pair of the spring pairs is connected to a respective wheel of one of top wheels or side wheels. Clause 5. The movable carriage of clause 4, wherein each spring pair has two different stiffnesses. Clause 6. The movable carriage of clause 1 further comprising: a number of positioning plates comprising at least one of side positioning plates connecting the side wheels to sides of the frame at an angle configured to engage sides of the longitudinal component or top positioning plates connecting the top wheels to the frame and configured to place top wheels normal to a cross-sectional shape of the longitudinal component.

Clause 7. The movable carriage of clause 1, wherein the top wheels comprise a first top wheel pair positioned at a first angle relative to the center plane. Clause 8. The movable carriage of clause 7, wherein the top wheels comprise a second top wheel pair positioned at a second angle relative to the center plane, wherein the second angle is greater than the first angle. Clause 9. The movable carriage of claim 8, wherein the first angle is approximately 15 degrees and the second angle is approximately 30 degrees. Clause 10. The movable carriage of clause 1, wherein the side wheels and the top wheels are facing into the operating volume. Clause 11. The movable carriage of clause 1 further comprising: a movement system connected to the frame and configured to move the movable carriage in a direction parallel to the center plane.

Clause 12. The movable carriage of clause 11, wherein the movement system comprises wheels configured to travel on a track system. Clause 13. The movable carriage of clause 11, wherein the movement system comprises a motor configured to at least partially drive the movable carriage parallel to the center plane.

Clause 14. The movable carriage of clause 1, wherein the side wheels are connected to the sides of the frame and the top wheels are connected to the top of the frame. Clause 15. The movable carriage of clause 1, wherein the side wheels comprise a first side wheel pair symmetric about the center plane and a second side wheel pair symmetric about the center plane and offset from the first side wheel pair along the center plane; and wherein the top wheels comprise a first top wheel pair symmetric about the center plane and angled away from each other at a first angle; and a second top wheel pair symmetric about the center plane and angled away from each other at a second angle, wherein the second angle of the second top wheel pair is greater than the first angle of the first top wheel pair. Clause 16. The movable carriage of clause 1, wherein the side wheels and top wheels are formed of a material having a coefficient of friction with the material sheet sufficient to guide the material sheet around the longitudinal component.

Clause 17. A movable carriage configured to wrap a material sheet around a longitudinal component, the movable carriage comprising: a frame defining a center plane and an operating volume; a plurality of wheels within the operating volume arranged as a plurality of stages offset from each other along the center plane of the frame, wherein angles of wheels of each respective stage of the plurality of stages increase along the center plane; and a number of positioning plates connected to the frame and holding the plurality of wheels normal to a cross-sectional shape of the longitudinal component.

Clause 18. The movable carriage of clause 17, wherein the number of positioning plates is adjustable and configured to adjust a position of the plurality of wheels within the operating volume. Clause 19. The movable carriage of clause 17, wherein the plurality of wheels is spring-loaded. Clause 20. The movable carriage of clause 17, wherein the plurality of wheels is configured to provide a normal force to a cross-sectional shape of the longitudinal component. Clause 21. The movable carriage of clause 17 further comprising: springs arranged in spring pairs, wherein each spring pair of the spring pairs is connected to a respective wheel of the plurality of wheels.

Clause 22. The movable carriage of claim 21, wherein each spring pair has two different stiffnesses. Clause 23. The movable carriage of clause 17 wherein a first angle of a wheel in a first stage of the plurality of wheels is approximately 15 degrees, and wherein a second angle of a wheel in a second stage of the plurality of wheels is approximately 30 degrees. Clause 24. The movable carriage of clause 17, wherein the plurality of wheels is facing into the operating volume.

Clause 25. The movable carriage of clause 17 further comprising: a movement system connected to the frame and configured to move the movable carriage in a direction parallel to the center plane. Clause 26. The movable carriage of claim 25, wherein the movement system comprises wheels configured to travel on a track system. Clause 27. The movable carriage of claim 25, wherein the movement system comprises a motor configured to at least partially drive the movable carriage parallel to the center plane. Clause 28. The movable carriage of clause 17, wherein the plurality of wheels is formed of a material having a coefficient of friction with the material sheet sufficient to guide the material sheet around the longitudinal component.

Clause 29. A method of wrapping a material sheet around a longitudinal component, the method comprising: positioning a movable carriage such that a longitudinal component is within an operating volume beneath a frame of the movable carriage; moving the movable carriage in a direction parallel to a longitudinal axis of the longitudinal component; and guiding the material sheet around the longitudinal component using wheels of the movable carriage within the operating volume as the movable carriage moves in the direction.

Clause 30. The method of claim 29, wherein moving the movable carriage comprises moving the movable carriage along a track system of a work table supporting the longitudinal component. Clause 31. The method of claim 29, wherein guiding the material sheet around the longitudinal component using the wheels comprises: guiding the material sheet onto sides of the longitudinal component using side wheels connected to sides of the frame and arranged as opposing pairs about a center plane defined by the frame; and guiding the material sheet onto a top of the longitudinal component using top wheels connected to a top of the frame and arranged as opposing pairs about the center plane. Clause 32. The method of claim 29, wherein guiding the material sheet around the longitudinal component using wheels of the movable carriage within the operating volume as the movable carriage moves in the direction comprises sequentially contacting the material sheet with opposing pairs of wheels at increasing angles relative to the direction. Clause 33. The method of claim 29, wherein moving the movable carriage comprises at least partially powering movement of the movable carriage using a motor. Clause 34. The method of claim 29, wherein guiding the material sheet around the longitudinal component comprises passively driving the wheels by the moving of the movable carriage in the direction.

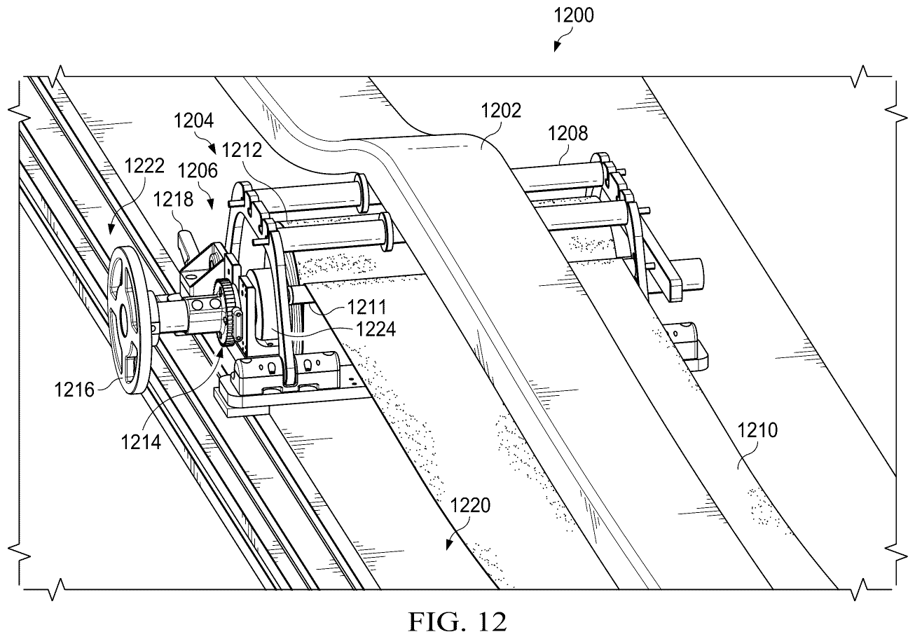

Turning now to FIG. 11, an illustration of a block diagram of a manufacturing environment is depicted in accordance with an illustrative embodiment. In manufacturing environment, material wrapping system 1102 can be used to wrap material sheet 1134 around longitudinal component 1108. Material wrapping system 1102 comprises material sheet tensioning dispenser 1104 and movable carriage 1106. Movable carriage 1106 can be the same as movable carriage 202 of FIG. 2. In some illustrative examples, movable carriage 402 of FIGS. 4-7 can be an example of movable carriage 1106. In some illustrative examples, movable carriage 1106 and material sheet tensioning dispenser 1104 can be used to wrap plurality of material sheets 303 in FIG. 3. In some illustrative examples, movable carriage 1106 and material sheet tensioning dispenser can be used to perform method 800 of FIG. 8.

Material sheet tensioning dispenser 1104 maintains tension in material sheet 1134 as movable carriage 1106 urges material sheet 1134 up and around longitudinal component 1108. Applying tension to material sheet 1134 reduces or prevents wrinkles in material sheet 1134.

Material sheet tensioning dispenser 1104 and movable carriage 1106 are moved sequentially to wrap material sheet 1134 around longitudinal component 1108. Material sheet tensioning dispenser 1104 is positioned and locked relative to track system 1160. Afterwards, movable carriage 1106 is positioned relative to material sheet tensioning dispenser 1104. Movable carriage 1106 moves towards material sheet tensioning dispenser 1104 to guide material sheet 1134 around longitudinal component 1108.

In some illustrative examples, material wrapping system 1102 comprises material sheet tensioning dispenser 1104 and movable carriage 1106. In some illustrative examples, movable carriage 1106 can be referred to as material wrapping carriage 1105. Material sheet tensioning dispenser 1104 comprises positional lock 1156 configured to lock material wrapping system 1102 relative to track system 1160, material roll support 1148, and tensioning system 1138 configured to selectively prevent rotation of material roll 1130 on material roll support 1148. Movable carriage 1106 is configured to wrap material sheet 1134 dispensed from material roll 1130 around longitudinal component 1108 using side wheels 1165 and top wheels 1167 configured to guide material sheet 1134 against longitudinal component 1108 as movable carriage 1106 moves towards material sheet tensioning dispenser 1104.

Side wheels 1165 and top wheels 1167 can be referred to as interior facing wrap guiding wheels 1164. Interior facing wrap guiding wheels 1164 can be formed of any desirable material that provides sufficient friction without leaving residues on material sheet 1134. In some illustrative examples, interior facing wrap guiding wheels 1164 are formed of thermoplastic urethane (TPU).

Material sheet tensioning dispenser 1104 maintains tension on material sheet 1134 by preventing rotation of material roll 1130 within material sheet tensioning dispenser 1104 as movable carriage 1106 moves towards material sheet tensioning dispenser 1104. Tensioning system 1138 within material sheet tensioning dispenser 1104 is used to control tension on material roll 1130. Tensioning system 1138 comprises clamp 1140 to engage with material roll 1130 and tension lock 1144 to allow selective rotation of material roll 1130.

In some illustrative examples, clamp 1140 engages with inner diameter 1132 of material roll 1130. In some illustrative examples, clamp 1140 comprises at least one of air chuck 1142 or expandable mechanical chuck 1141. In some illustrative examples, air chuck 1142 or expandable mechanical chuck 1141 engages with an internal tube upon which material sheet 1134 is wrapped.

In some illustrative examples, to load material roll 1130 into material sheet tensioning dispenser 1104, material roll 1130 is placed onto material roll support 1148 and clamp 1140 is activated to restrain material roll 1130 relative to material roll support 1148. In some illustrative examples, activating clamp 1140 comprises expanding clamp 1140.

Tensioning system 1138 comprises tension lock 1144 configured to selectively disengage to allow rotation of material roll 1130. In some illustrative examples, tension lock 1144 comprises at least one of a ratchet and pawl 1146 or a magnetic lock 1145. To allow rotation of material roll 1130 in material sheet tensioning dispenser 1104, tension lock 1144 is disengaged and material sheet tensioning dispenser 1104 can be moved to dispense material sheet 1134.

In some illustrative examples, material sheet tensioning dispenser 1104 further comprises material film supporting roller 1120 configured to support material sheet 1134 as material sheet 1134 is dispensed from material roll 1130. In some illustrative examples, material film supporting roller 1120 comprises rotational axis 1121 higher than a rotational axis 1149 of material roll support 1148 relative to work table 1162. As material sheet 1134 is dispensed from material roll 1130, material sheet 1134 travels over material film supporting roller 1120 to maintain tension evenly across a width of material sheet 1134.

Longitudinal component 1108 can be sent over the top of material sheet tensioning dispenser 1104 to position longitudinal component 1108 onto material sheet 1134. As material sheet tensioning dispenser 1104 moves, material sheet tensioning dispenser 1104 moves beneath longitudinal component 1108 while in contact with longitudinal component 1108. To support longitudinal component 1108, material sheet tensioning dispenser 1104 further comprises longitudinal component support rollers 1118 above material roll support 1148. Longitudinal component support rollers 1118 are configured to position longitudinal component 1108 over material sheet 1134.

In some illustrative examples, flexible spacers 1122 are present on longitudinal component support rollers 1118. Flexible spacers 1122 are present to position longitudinal component 1108 on longitudinal component support rollers 1118. In some illustrative examples, flexible spacers 1122 are used to center longitudinal component 1108 on longitudinal component support rollers 1118.

Longitudinal component support rollers 1118 allow minimal deformation in longitudinal component 1108. Longitudinal component support rollers 1118 above the remainder of material sheet tensioning dispenser 1104 allows longitudinal component 1108 to sit over material sheet tensioning dispenser 1104, allowing the material sheet tensioning dispenser 1104 to be desirably close to movable carriage 1106. Allowing longitudinal component 1108 to sit over material sheet tensioning dispenser 1104 decreases a distance between material sheet tensioning dispenser 1104 and movable carriage 1106 for wrapping.

In some illustrative examples, material wrapping system 1102 comprises track system 1160, wherein material sheet tensioning dispenser 1104 and movable carriage 1106 comprise respective movement systems compatible with track system 1160. In this illustrative example, material sheet tensioning dispenser 1104 comprises movement system 1154. In this illustrative example, movable carriage 1106 comprises movement system 1166. Movement system 1154 and track system 1160 enable movement of material sheet tensioning dispenser 1104 across work table 1162. Movement system 1166 and track system 1160 enable movement of movable carriage 1106 across work table 1162. In some illustrative examples, material sheet tensioning dispenser 1104 and movable carriage 1106 can be motorized on track system 1160.

In some illustrative examples, movement system 1154 comprises wheels 1158. In some illustrative examples, movement system 1166 comprises wheels 1168. Movement system 1154 is configured to move material sheet tensioning dispenser 1104 in a direction parallel to a dispensing direction 1112 of the material sheet tensioning dispenser 1104. Material sheet 1134 is dispensed in dispensing direction 1112 when material sheet tensioning dispenser 1104 moves in movement direction 1114.

To wrap material sheet 1134 around longitudinal component 1108, a first length of material sheet 1134 is dispensed from material roll 1130 in material sheet tensioning dispenser 1104 onto work table 1162. To dispense the first length of material sheet 1134, material sheet tensioning dispenser 1104 is moved across work table 1162. As material sheet tensioning dispenser 1104 is moved across work table 1162, clamp 1140 is activated against material roll 1130 but tension lock 1144 is disengaged to allow rotation of material roll 1130. Dispensing the first length of material sheet 1134 comprises supporting material sheet 1134 using a material film supporting roller 1120 as material sheet 1134 is dispensed. As material sheet 1134 is dispensed, it moves across material film supporting roller 1120.

In some illustrative examples, end 1136 of material sheet 1134 is secured to work table 1162 prior to dispensing the first length of material sheet 1134. End 1136 can be secured to work table 1162 in any desirable fashion. In some illustrative examples, end 1136 of material sheet 1134 can be restrained from movement relative to work table 1162 by being secured to a component connected to work table 1162.

In some illustrative examples, end 1136 of material sheet 1134 can be taped beyond a starting position. In some illustrative examples, end 1136 of material sheet 1134 can be clamped beyond a starting position. A starting position can be indicated by an indexing system.

After dispensing a first length of material sheet 1134, material sheet tensioning dispenser 1104 is locked in a location on work table 1162. Material sheet tensioning dispenser 1104 is locked relative to work table 1162 by positional lock 1156 of material sheet tensioning dispenser 1104. Positional lock 1156 takes any desirable form. In some illustrative examples, positional lock 1156 comprises a brake, a clamp, a pin, or any other desirable type of lock. In some illustrative examples, an end of material sheet 1134 is secured to longitudinal component 1108 prior to moving movable carriage 1106. In some illustrative examples, material sheet tensioning dispenser 1104 is locked in a location that is a fixed, discrete, pre-determined location on work table 1162.

Longitudinal component 1108 is positioned over the first length of material sheet 1134 on work table 1162. Positioning longitudinal component 1108 over the first length of material sheet 1134 further comprises positioning longitudinal component 1108 over longitudinal component support rollers 1118 of material sheet tensioning dispenser 1104.

In some illustrative examples, longitudinal component 1108 is pressurized prior to wrapping material sheet 1134 around longitudinal component 1108. An end cap can be positioned on longitudinal component 1108 to maintain the pressurization within the longitudinal component 1108. Material roll 1130 is locked within material sheet tensioning dispenser 1104 using tensioning system 1138 to maintain tension on material sheet 1134.

Movable carriage 1106 is positioned such that longitudinal component 1108 is within an operating volume beneath a frame 1116 of movable carriage 1106. Movable carriage 1106 is moved in a direction parallel to longitudinal axis 1110 of longitudinal component 1108 a first distance towards material sheet tensioning dispenser 1104 to guide at least a portion of the first length of material sheet 1134 around longitudinal component 1108 as material sheet tensioning dispenser 1104 maintains tension on material sheet 1134. The first distance moved by movable carriage 1106 can be less than a distance between material sheet tensioning dispenser 1104 and movable carriage 1106.

After wrapping the portion of the first length of material sheet 1134 around longitudinal component 1108, movable carriage 1106 can stop moving. Movable carriage 1106 and material sheet tensioning dispenser 1104 can repeatedly be moved in sequence to fully wrap longitudinal component 1108. After movable carriage 1106 is stationary, material sheet tensioning dispenser 1104 can dispense a second length of material sheet 1134.

Material roll 1130 is released by deactivating tensioning system 1138 after moving movable carriage 1106 the first distance. Material sheet tensioning dispenser 1104 is moved a second distance away from movable carriage 1106 to dispense a second length of material sheet 1134. When moving material sheet tensioning dispenser 1104 a second distance away from movable carriage 1106 to dispense a second length of material sheet 1134 after wrapping at least a portion of the first length of material sheet 1134 around longitudinal component 1108, longitudinal component 1108 rolls over longitudinal component support rollers 1118 as material sheet tensioning dispenser 1104 moves relative to work table 1162. Material sheet tensioning dispenser 1104 is then locked in a second location on work table 1162 after moving material sheet tensioning dispenser 1104 the second distance. Material roll 1130 is locked within material sheet tensioning dispenser 1104 using tensioning system 1138 after locking material sheet tensioning dispenser 1104 in the second location.

Movable carriage 1106 is moved in the direction parallel to longitudinal axis 1110 of longitudinal component 1108 a second distance towards material sheet tensioning dispenser 1104 to guide at least a portion of the second length of material sheet 1134 around longitudinal component 1108. By moving movable carriage 1106 the second distance, the first length of material sheet 1134 has been completely wrapped around longitudinal component 1108.

In some illustrative examples to wrap material sheet 1134, material sheet tensioning dispenser 1104 is positioned about 30 feet ahead of movable carriage 1106. Material sheet 1134 is pulled out and taped to work table 1162 at an optional index location.

Longitudinal component 1108 is placed over longitudinal component support rollers 1118. A preliminary portion of material sheet 1134 can be taped to an end of longitudinal component 1108. In some illustrative examples, the first two feet of material sheet 1134 is taped to longitudinal component 1108. In some illustrative examples, material sheet 1134 is taped to work table 1162 and then a portion of material sheet 1134 is cut to wrap around longitudinal component 1108. In these illustrative examples, material sheet 1134 is cut near longitudinal component 1108, and material sheet 1134 is pulled over longitudinal component 1108.

In some illustrative examples, movable carriage 1106 is positioned over the manually wrapped area. Movable carriage 1106 can be moved to wrap material sheet 1134 until a bladder flex point near material sheet tensioning dispenser 1104.

In some illustrative examples, the flex point is where longitudinal component 1108 lifts away from work table 1162. When movable carriage 1106 reaches the point at which longitudinal component 1108 lifts away from work table 1162, it is time to move material sheet tensioning dispenser 1104 in movement direction 1114.

In some illustrative examples, to dispense material sheet 1134, tension lock 1144 is disengaged and material sheet tensioning dispenser 1104 is moved to dispense 20-30 feet of material sheet 1134. To manually move material sheet tensioning dispenser 1104 in some illustrative examples, tension lock 1144 is disengaged and held open while pulling. Afterwards, tension lock 1144 is released and positional lock 1156 is set. Tension is then applied to material sheet 1134 using tensioning system 1138.

Movement steps are continued until reaching the end of longitudinal component 1108. Interior facing wrap guiding wheels 1164 can be pulled away from longitudinal component 1108 before removing movable carriage 1106.

In some illustrative examples, material sheet tensioning dispenser 1104 comprises positional lock 1156, material roll support 1148, and tensioning system 1138. Positional lock 1156 is configured to maintain a position of material sheet tensioning dispenser 1104 relative to a work table 1162. Material roll support 1148 is configured to rotatably support material roll 1130. Tensioning system 1138 is configured to selectively prevent rotation of material roll 1130 on material roll support 1148. In some illustrative examples, tensioning system 1138 comprises a clamp 1140 configured to engage with material roll 1130 on material roll support 1148.

In some illustrative examples, material wrapping system 1102 comprises auxiliary cart 1170 providing a storage volume 1172 connected to movable carriage 1106. Auxiliary cart 1170 can be used to store any tools, materials, or other desirable equipment to be used alongside wrapping longitudinal component 1108. In some illustrative examples, auxiliary cart 1170 comprises a tape dispensing system in storage volume 1172. The tape dispensing system can either automatically apply tape to the wrapped material or present dispensed tape to an operator.

In some illustrative examples, measurement component 1174 attached to auxiliary cart 1170. Measurement component 1174 can be used to measure any desirable aspect of material sheet 1134. In some illustrative examples, measurement component 1174 can be used to measure an overlap of material sheet 1134 around longitudinal component 1108. In some illustrative examples, measurement component 1174 can be used to measure a gap between pieces of tape securing material sheet 1134 in the wrapped position. In some illustrative examples, measurement component 1174 is positioned parallel to movement direction 1114 of movable carriage 1106 and material sheet tensioning dispenser 1104. In some illustrative examples, measurement component 1174 is positioned perpendicular to a movement direction 1114 of movable carriage 1106 and material sheet tensioning dispenser 1104.

In some illustrative examples, material sheet tensioning dispenser 1104 comprises frame 1116. Frame 1116 positions and structurally supports components of material sheet tensioning dispenser 1104. In some illustrative examples, frame 1116 comprises longitudinal component support rollers 1118 above material roll support 1148.

In some illustrative examples, frame 1116 is movably connected 1126 to material sheet tensioning dispenser 1104 to access material roll support 1148. Frame 1116 can be movably connected 1126 to material sheet tensioning dispenser 1104 by hinge 1128. Frame 1116 can have any desirable shape. In some illustrative examples, frame 1116 is C-shaped 1124. In some illustrative examples, frame 1116 comprises material film supporting roller 1120.

Movable carriage 1106 can be described as a zipper mechanism with angled compliant wheels that pull up material sheet 1134 to wrap around longitudinal component 1108. Material sheet tensioning dispenser 1104 rides under longitudinal component 1108 in front of movable carriage 1106 to keep material sheet 1134 in tension during wrapping. In some illustrative examples, material sheet tensioning dispenser 1104 travels around 20-30 ft in front of movable carriage 1106.

The illustration of manufacturing environment 1100 in FIG. 11 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, longitudinal component 1108 can be an inflatable bladder. In these illustrative examples, a bladder inflation system can be present in manufacturing environment 1100 to keep longitudinal component 1108 at a desired pressure during wrapping. As another example, a bladder indexing system can be present on one end of longitudinal component 1108. In some illustrative examples, longitudinal component 1108 is restrained relative to work table 1162. In some illustrative examples, an end of longitudinal component 1108 is locally restrained from lateral movement relative work table 1162. In some illustrative examples, longitudinal component 1108 can be pinned to indexing holes. In some illustrative examples, longitudinal component 1108 can be restrained from movement at either end. In some illustrative examples, a restraint for longitudinal component 1108 comprises at least one of a weight, clamp, an end cap, a pin, a frame, or any other desirable form of restraint.

Although only a single movable carriage, movable carriage is depicted, in some illustrative examples, more than one material type and more than one movable carriage is present. In some illustrative examples, an equal quantity of movable carriages and material sheet tensioning dispenser are present. For example, three movable carriages can be present along with three different dispensing units.

In some illustrative examples, material sheet tensioning dispenser 1104 can accommodate three rolls of material at once. In these illustrative examples, material wrapping system 1102 comprises three movable carriages that can be used simultaneously a few feet apart to wrap all three layers at once.

Material sheet tensioning dispenser 1104 is positioned a set distance from movable carriage 1106 prior to beginning wrapping material sheet 1134. In some illustrative examples, material sheet tensioning dispenser 1104 is positioned 20-30 ft away from movable carriage 1106. By material sheet tensioning dispenser 1104 being no more than 20-30 ft away from movable carriage 1106, material sheet tensioning dispenser 1104 and movable carriage 1106 can be incrementally moved along longitudinal component 1108. For example, a 100 foot long longitudinal component 1108 can be separated into approximately four to five separate wrapping regions that material sheet tensioning dispenser 1104 and movable carriage 1106 can move through in the same quantity of movements.

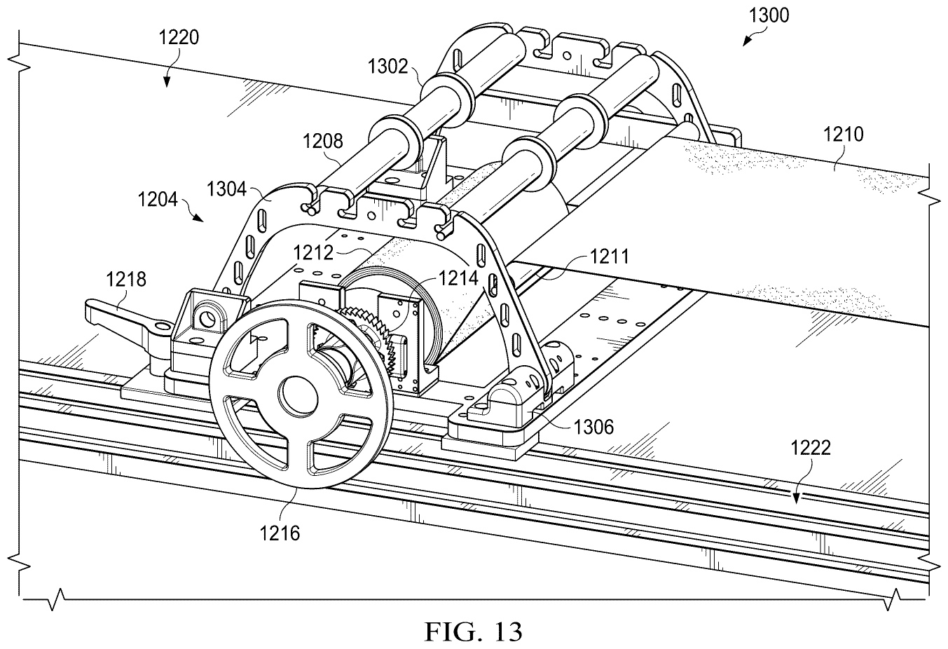

Turning now to FIG. 12, an illustration of a material sheet tensioning dispenser within a manufacturing environment is depicted in accordance with an illustrative embodiment. Material sheet tensioning dispenser 1204 is a physical implementation of material sheet tensioning dispenser 1104 of FIG. 11. Material sheet tensioning dispenser 1204 can be used in conjunction with movable carriage 202 of FIG. 2. Material sheet tensioning dispenser 1204 can be used in conjunction with movable carriage 202 of FIG. 2. Material sheet tensioning dispenser 1204 can be used in conjunction with movable carriage 402 of FIGS. 4-7.

In view 1200, longitudinal component 1202 is positioned over material sheet tensioning dispenser 1204. Longitudinal component 1202 takes any desirable form. In this illustrative example, longitudinal component 1202 is an inflatable bladder. Longitudinal component 1202 is in contact with longitudinal component support rollers 1208 of material sheet tensioning dispenser 1204. As material sheet tensioning dispenser 1204 moves along work table 1220, longitudinal component support rollers 1208 rotate due to the movement of material sheet tensioning dispenser 1204 relative to longitudinal component 1202.

Material sheet tensioning dispenser 1204 comprises positional lock 1218 configured to maintain a position of material sheet tensioning dispenser 1204 relative to work table 1220, a material roll support 1224 configured to rotatably support material roll 1212, and tensioning system 1206 configured to selectively prevent rotation of material roll 1212 on the material roll support 1224. Material sheet tensioning dispenser 1204 can move relative to work table 1220 using track system 1222.

Tensioning system 1206 comprises a clamp (not depicted) configured to engage with material roll 1212 on the material roll support 1224. The clamp engages with an interior of material roll 1212 such as a tube. In some illustrative examples, the clamp comprises at least one of an air chuck or an expandable mechanical chuck. In some illustrative examples, the at least one of an air chuck or an expandable mechanical chuck presses against an interior of the tube.

Tensioning system 1206 comprises a tension lock configured to selectively disengage. In this illustrative example, the tension lock comprises ratchet and pawl 1214. In tensioning system 1206, wheel 1216 allows for manual rotation of material roll 1212 to place tension into material sheet 1210. When material sheet tensioning dispenser 1204 is locked in a position, wheel 1216 can be turned in a direction opposite the dispensing direction to adjust tension in material sheet 1210.

Material sheet tensioning dispenser 1204 further comprises material film supporting roller 1211 is configured to support material sheet 1210 as material sheet 1210 is dispensed from material roll 1212. Material film supporting roller 1211 comprises a rotational axis higher than a rotational axis of the material roll support 1224 relative to work table 1220.

Material sheet tensioning dispenser 1204 further comprises longitudinal component support rollers 1208 above material roll support 1224.

Material sheet 1210 is dispensed from material roll 1212 within material sheet tensioning dispenser 1204. Material sheet 1210 is unwrapped from material roll 1212 and sent over material film supporting roller 1211.

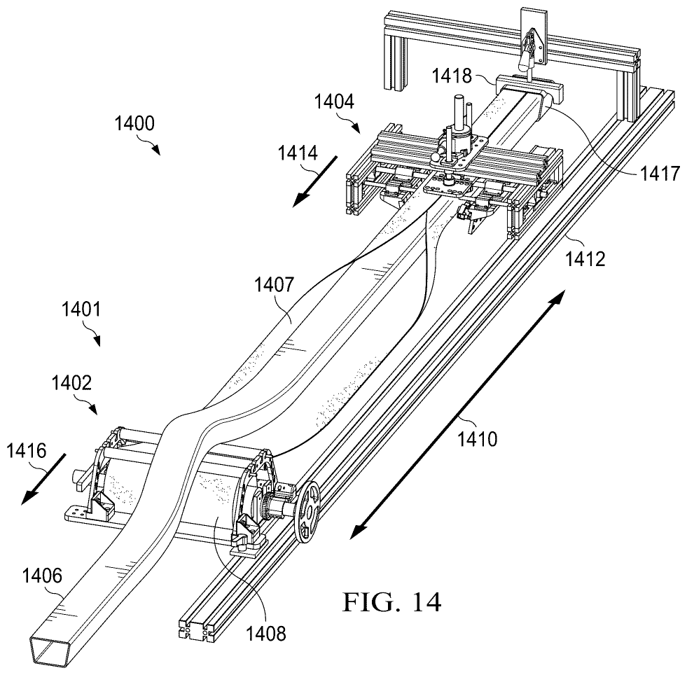

Turning now to FIG. 13, an illustration of a material sheet tensioning dispenser within a manufacturing environment is depicted in accordance with an illustrative embodiment. View 1300 is an isometric view of material sheet tensioning dispenser 1204 prior to placing longitudinal component 1202 onto material sheet tensioning dispenser 1204.

In view 1300, flexible spacers 1302 are visible. Flexible spacers 1302 provide borders for a longitudinal component. Flexible spacers 1302 provide positioning for a longitudinal component. Flexible spacers 1302 can be used to center a longitudinal component over material sheet 1210.

In view 1300, ratchet and pawl 1214, wheel 1216, and positional lock 1218 are more clearly viewed. In view 1300, frame 1304 is visible. Frame 1304 can be described as a cage. In this illustrative example, frame 1304 is C-shaped. Frame 1304 is movable relative to the remainder of material sheet tensioning dispenser 1204. Frame 1304 is movably connected to material sheet tensioning dispenser 1204 to access material roll support 1224.

Frame 1304 can be rotated about hinge 1306 to insert or remove material roll 1212. In this illustrative example, frame 1304 comprises longitudinal component support rollers 1208 and material film supporting roller 1211.

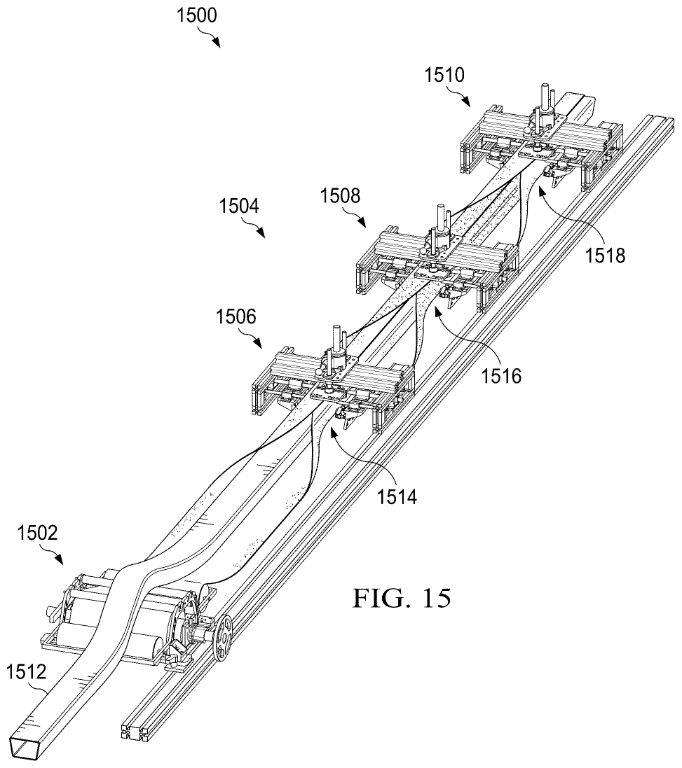

Turning now to FIG. 14, an illustration of a material wrapping system within a manufacturing environment is depicted in accordance with an illustrative embodiment. Material wrapping system 1401 is a physical implementation of material wrapping system 1102 of FIG. 11. In some illustrative examples, material sheet tensioning dispenser 1402 can be the same as material sheet tensioning dispenser 1204 of FIGS. 12 and 13. Movable carriage 1404 can be an implementation of movable carriage 202 of FIG. 2. Movable carriage 1404 can be the same as movable carriage 402 of FIGS. 4-7.

In view 1400, material sheet tensioning dispenser 1402 has dispensed material sheet 1407 from material roll 1408. In view 1400, movable carriage 1404 is wrapping material sheet 1407 around longitudinal component 1406.

Movable carriage 1404 is movable along track system 1412 in direction 1414. Material sheet tensioning dispenser 1402 is movable along track system 1412 in direction 1416. Material sheet tensioning dispenser 1402 moves in direction 1416 along track system 1412 prior to moving movable carriage 1404. Prior to moving movable carriage 1404, material sheet tensioning dispenser 1402 is locked relative to track system 1412 and a work table (not depicted).

Prior to wrapping material sheet 1407 around longitudinal component 1406, material sheet tensioning dispenser 1402 is positioned a distance away from movable carriage 1404. Distance 1410 between material sheet tensioning dispenser 1402 and movable carriage 1404 is configured to maintain sufficient tension in material sheet 1407. Distance 1410 between material sheet tensioning dispenser 1402 and movable carriage 1404 is configured to allow for efficient movement of material sheet tensioning dispenser 1402 and movable carriage 1404. In some illustrative examples, distance 1410 between material sheet tensioning dispenser 1402 and movable carriage 1404 is between twenty feet and thirty feet.

In this illustrative example, longitudinal component 1406 is restrained from lateral movement relative to the work table locally by restraint 1418. More specifically, end 1417 of longitudinal component 1406 is held by restraint 1418. In some illustrative examples, restraint 1418 comprises at least one of a clamp, an end cap, a pin, a frame, or any other desirable form of restraint.

View 1400 is a view of a portion of longitudinal component 1406. To wrap material sheet 1407 around an entirety of longitudinal component 1406, material sheet tensioning dispenser 1402 and movable carriage 1404 are moved in series. To wrap material sheet 1407 around an entirety of longitudinal component 1406, material sheet tensioning dispenser 1402 is first moved in direction 1416. Once material sheet tensioning dispenser 1402 is locked on track system 1412, movable carriage 1404 can be moved in direction 1414 to wrap material sheet 1407 around longitudinal component 1406. Movable carriage 1404 is moved a distance shorter than distance 1410. After moving a desired distance, movable carriage 1404 stops and the movement of material sheet tensioning dispenser 1402 and movable carriage 1404 repeat serial movements until longitudinal component 1406 is wrapped by material sheet 1407.

In view 1400, a single material, material sheet 1407 is dispensed from material sheet tensioning dispenser 1402. In some illustrative examples, more than one material sheet can be wrapped around a longitudinal component. In view 1500, more than one material sheet can be dispensed from a single material sheet tensioning dispenser.

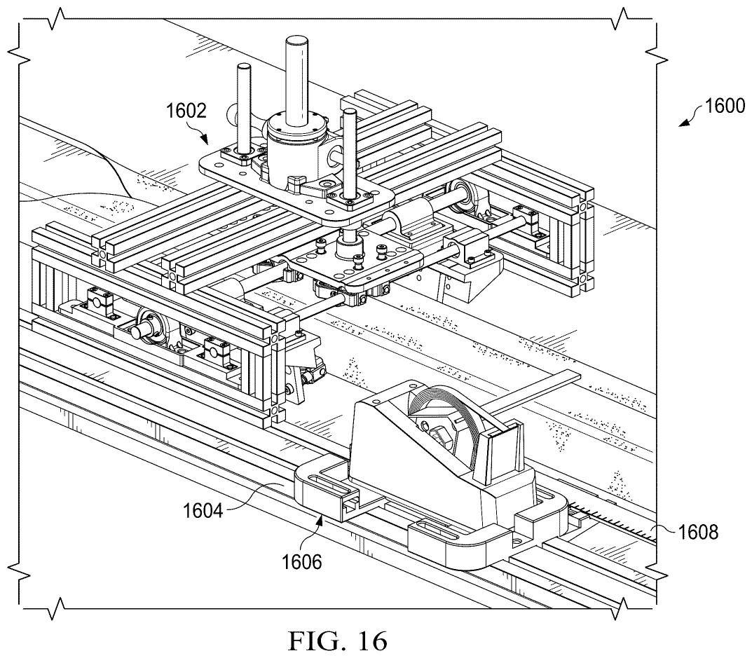

Turning now to FIG. 15, an illustration of a material wrapping system within a manufacturing environment is depicted in accordance with an illustrative embodiment. Material wrapping system 1501 is a physical implementation of material wrapping system 1102 of FIG. 11. Movable carriages 1504 can each be an implementation of movable carriage 202 of FIG. 2. At least one of movable carriage 1506, movable carriage 1508, or movable carriage 1510 can be the same as movable carriage 402 of FIGS. 4-7.

In this illustrative example, material sheet tensioning dispenser 1502 dispenses three different material sheets, first material sheet 1514, second material sheet 1516, and third material sheet 1518. In other non-depicted examples, more than one material sheet tensioning dispenser can be provided. In some illustrative examples, each material sheet tensioning dispenser dispenses a single material sheet.

In this illustrative example, material wrapping carriages 1504 comprise material wrapping carriage 1506, material wrapping carriage 1508, and material wrapping carriage 1510. Material wrapping carriage 1506 wraps first material sheet 1514 around longitudinal component 1512. Material wrapping carriage 1508 wraps second material sheet 1516 around longitudinal component 1512. Material wrapping carriage 1510 wraps third material sheet 1518 around longitudinal component 1512.

In some illustrative examples, each of material wrapping carriages 1504 is moved independently. In some illustrative examples, material wrapping carriage 1506 moves a first desired distance. In some illustrative examples, material wrapping carriage 1508 moves after material wrapping carriage 1506 stops moving. In some illustrative examples, material wrapping carriage 1510 moves after material wrapping carriage 1508 stops moving.

In some illustrative examples, each of material wrapping carriages 1504 is moved substantially simultaneously. While any of material wrapping carriages 1504 is moving, material sheet tensioning dispenser 1502 is stationary.

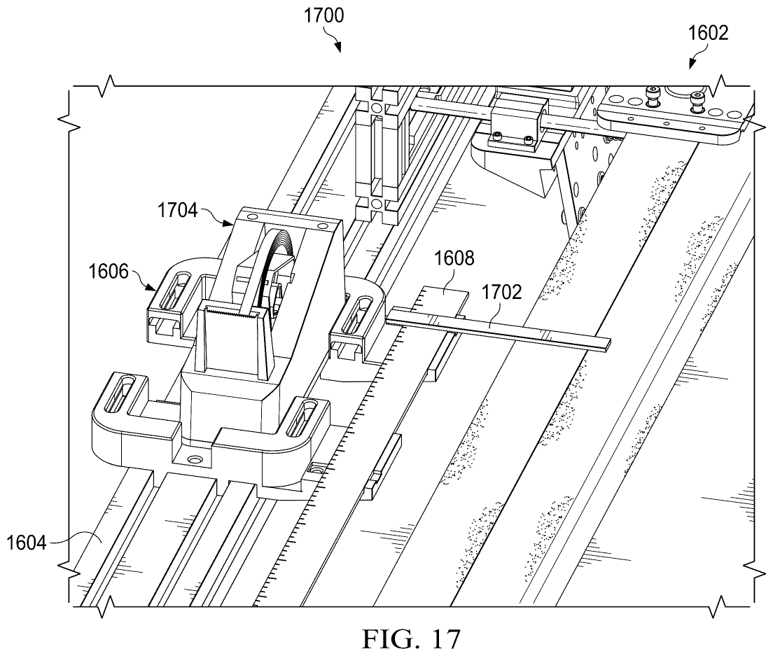

Turning now to FIG. 16, an illustration of portions of a material wrapping system within a manufacturing environment is depicted in accordance with an illustrative embodiment. Movable carriage 1602 is a physical implementation of movable carriage 202 of FIG. 2. Movable carriage 1602 can be the same as movable carriage 402 of FIGS. 4-7. Movable carriage 1602 can be the same as movable carriage 1404 of FIG. 14. Movable carriage 1602 can be the same as at least one of movable carriage 1506, movable carriage 1508, or movable carriage 1510 of FIG. 15.

In this illustrative example, auxiliary cart 1606 is connected to movable carriage 1602. Auxiliary cart 1606 enables additional auxiliary functions to be performed in conjunction with wrapping the material sheet around the longitudinal component. Auxiliary cart 1606 can be used for storing additional materials or components.

The connection to movable carriage 1602 maintains a set distance between movable carriage 1602 and auxiliary cart 1606. In some illustrative examples, as movable carriage 1602 moves along track system 1604, movable carriage 1602 moves auxiliary cart 1606 along track system 1604. In some illustrative examples, auxiliary cart 1606 comprises a movement system to allow movement along track system 1604.

Measurement component 1608 is attached to auxiliary cart 1606. Measurement component 1608 enables measurement of spacing between taping of a material sheet on a longitudinal component. Measurement component 1608 is positioned parallel to a movement direction movable carriage 1602 and the material sheet tensioning dispenser (not depicted).

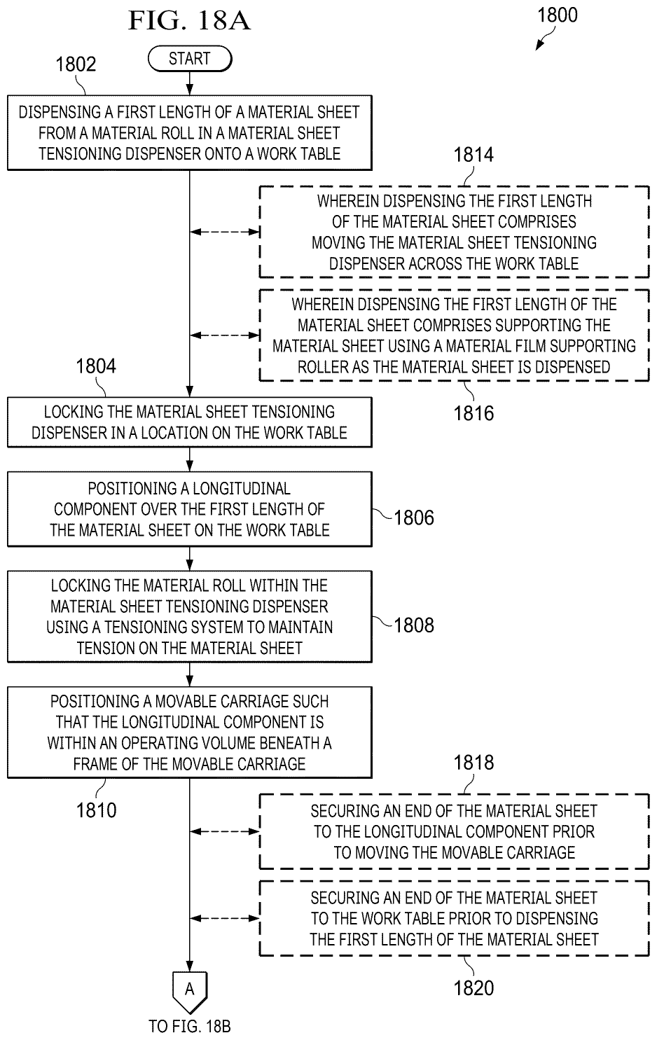

Turning now to FIG. 17, an illustration of an auxiliary cart within a manufacturing environment is depicted in accordance with an illustrative embodiment. View 1700 is an elevated back view of auxiliary cart 1606.

Auxiliary cart 1606 provides storage volume 1704 connected to movable carriage 1602. In this illustrative example, storage volume 1704 contains a tape dispenser. Storage volume 1704 can be used to store any desirable components or materials to be used in conjunction with wrapping the material sheet around the longitudinal component.

In this illustrative example, two measurement components, measurement component 1608 and measurement component 1702, are attached to auxiliary cart 1606. Measurement component 1702 is positioned perpendicular to a movement direction of movable carriage 1602 and the material sheet tensioning dispenser (not depicted). Measurement component 1702 can be used to measure an overlap of the material sheet on the longitudinal component. In some illustrative examples, wrap quality is measured by the amount of wrap material overlap. The illustrative examples are configured to produce a more consistent overlap than manually wrapping. Mounting of measurement component 1608 and measurement component 1702 can save time and increase accuracy of measurements by maintaining a relative position of measurement component 1608 and measurement component 1702 relative to movable carriage 1602.

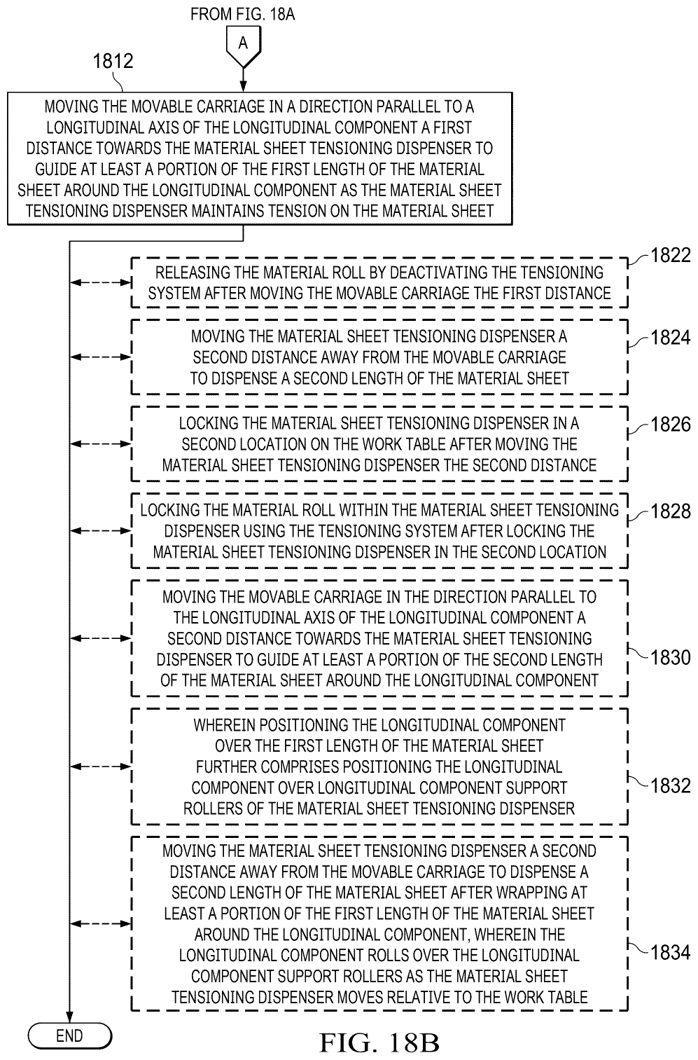

Turning now to FIGS. 18A and 18B, a flowchart of a method of wrapping a material sheet around a longitudinal component is depicted in accordance with an illustrative embodiment. Method 1800 can be used to form a composite component of aircraft 100 of FIG. 1. Method 1800 can be performed using movable carriage 202 of FIG. 2. Method 1800 can be performed to wrap a material sheet around longitudinal component 301 of FIG. 3. Method 1800 can be performed using movable carriage 402 of FIGS. 4-7. Method 1800 can be performed using material wrapping system 1102 of FIG. 11. Method 1800 can be performed using material sheet tensioning dispenser 1204 of FIGS. 12-13. Method 1800 can be performed using material wrapping system 1401 of FIG. 14. Method 1800 can be performed using material wrapping system 1501 of FIG. 15. Method 1800 can be performed using movable carriage 1602 of FIGS. 16-17.

Method 1800 dispenses a first length of a material sheet from a material roll in a material sheet tensioning dispenser onto a work table (operation 1802). Method 1800 locks the material sheet tensioning dispenser in a location on the work table (operation 1804). In some illustrative examples, the material sheet tensioning dispenser is locked in a location that is a fixed, discrete, pre-determined location on the work table. Method 1800 positions a longitudinal component over the first length of the material sheet on the work table (operation 1806).

Method 1800 locks the material roll within the material sheet tensioning dispenser using a tensioning system to maintain tension on the material sheet (operation 1808). Method 1800 positions a movable carriage such that the longitudinal component is within an operating volume beneath a frame of the movable carriage (operation 1810). Method 1800 moves the movable carriage in a direction parallel to a longitudinal axis of the longitudinal component a first distance towards the material sheet tensioning dispenser to guide at least a portion of the first length of the material sheet around the longitudinal component as the material sheet tensioning dispenser maintains tension on the material sheet (operation 1812). Afterwards, method 1800 terminates.

In some illustrative examples, dispensing the first length of the material sheet comprises moving the material sheet tensioning dispenser across the work table (operation 1814). Dispensing the first length of the material sheet is performed by moving the material sheet tensioning dispenser in a movement direction opposite the dispensing direction of the material sheet.

In some illustrative examples, dispensing the first length of the material sheet comprises supporting the material sheet using a material film supporting roller as the material sheet is dispensed (operation 1816). The material film supporting roller can evenly distribute tension across the width of the material sheet.

In some illustrative examples, method 1800 secures an end of the material sheet to the longitudinal component prior to moving the movable carriage (operation 1818). In some illustrative examples, method 1800 secures an end of the material sheet to the work table prior to dispensing the first length of the material sheet (operation 1820).

In some illustrative examples, method 1800 releases the material roll by deactivating the tensioning system after moving the movable carriage the first distance (operation 1822). In some illustrative examples, method 1800 releases the material roll by deactivating a tension lock such as a ratchet and pawl or a magnetic lock.

In some illustrative examples, method 1800 moves the material sheet tensioning dispenser a second distance away from the movable carriage to dispense a second length of the material sheet (operation 1824). In some illustrative examples, method 1800 locks the material sheet tensioning dispenser in a second location on the work table after moving the material sheet tensioning dispenser the second distance (operation 1826). In some illustrative examples, method 1800 locks the material roll within the material sheet tensioning dispenser using the tensioning system after locking the material sheet tensioning dispenser in the second location (operation 1828). In some illustrative examples, method 1800 moves the movable carriage in the direction parallel to the longitudinal axis of the longitudinal component a second distance towards the material sheet tensioning dispenser to guide at least a portion of the second length of the material sheet around the longitudinal component (operation 1830).

In some illustrative examples, positioning the longitudinal component over the first length of the material sheet further comprises positioning the longitudinal component over longitudinal component support rollers of the material sheet tensioning dispenser (operation 1832). The longitudinal component support rollers enable movement of the material sheet tensioning dispenser beneath the longitudinal component as the material sheet tensioning dispenser dispenses the material sheet. In some illustrative examples, method 1800 moves the material sheet tensioning dispenser a second distance away from the movable carriage to dispense a second length of the material sheet after wrapping at least a portion of the first length of the material sheet around the longitudinal component, wherein the longitudinal component rolls over the longitudinal component support rollers as the material sheet tensioning dispenser moves relative to the work table (operation 1834).

The illustrative examples reduce processing time for composite manufacturing. The illustrative examples reduce processing time for wrapping a longitudinal component in a material sheet. The illustrative examples can reduce flow time from multiple hours for a longitudinal component to less than an hour. In some examples, the illustrative examples can reduce flow to less than 50% of manual time for a longitudinal component. In some examples, the illustrative examples can reduce flow to less than 50% of manual time for a longitudinal component. In some examples, the illustrative examples can reduce flow to less than 40% of manual time for a longitudinal component. In some examples, the illustrative examples can reduce flow to less than 30% of manual time for a longitudinal component. In some examples, the illustrative examples can reduce flow to approximately 20% of manual time for a longitudinal component. When there are multiple longitudinal components, the time savings can be substantial.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A material wrapping system comprising:
a material sheet tensioning dispenser comprising a positional lock configured to lock the material wrapping system relative to a track system, a material roll support, and a tensioning system configured to selectively prevent rotation of a material roll on the material roll support; and
a movable carriage configured to wrap a material sheet dispensed from the material roll around a longitudinal component using side wheels and top wheels configured to guide the material sheet against the longitudinal component as the movable carriage moves towards the material sheet tensioning dispenser.

2. (canceled)

3. The material wrapping system of claim 1 further comprising:
an auxiliary cart providing a storage volume connected to the movable carriage.

4-6. (canceled)

7. The material wrapping system of claim 1, wherein the material sheet tensioning dispenser maintains tension on the material sheet by preventing rotation of the material roll within the material sheet tensioning dispenser as the movable carriage moves towards the material sheet tensioning dispenser.

8. The material wrapping system of claim 1, wherein the material sheet tensioning dispenser further comprises longitudinal component support rollers above the material roll support, the longitudinal component support rollers configured to position the longitudinal component over the material sheet.

9. A method of wrapping a material sheet around a longitudinal component, the method comprising:
dispensing a first length of a material sheet from a material roll in a material sheet tensioning dispenser onto a work table;
locking the material sheet tensioning dispenser in a location on the work table;
positioning a longitudinal component over the first length of the material sheet on the work table;
locking the material roll within the material sheet tensioning dispenser using a tensioning system to maintain tension on the material sheet;
positioning a movable carriage such that the longitudinal component is within an operating volume beneath a frame of the movable carriage; and
moving the movable carriage in a direction parallel to a longitudinal axis of the longitudinal component a first distance towards the material sheet tensioning dispenser to guide at least a portion of the first length of the material sheet around the longitudinal component as the material sheet tensioning dispenser maintains tension on the material sheet.

10. The method of claim 9 further comprising:
securing an end of the material sheet to the longitudinal component prior to moving the movable carriage.

11. The method of claim 9 further comprising:
securing an end of the material sheet to the work table prior to dispensing the first length of the material sheet.

12. The method of claim 9, wherein dispensing the first length of the material sheet comprises moving the material sheet tensioning dispenser across the work table.

13. The method of claim 9, wherein dispensing the first length of the material sheet comprises supporting the material sheet using a material film supporting roller as the material sheet is dispensed.

14. The method of claim 9 further comprising:
releasing the material roll by deactivating the tensioning system after moving the movable carriage the first distance;
moving the material sheet tensioning dispenser a second distance away from the movable carriage to dispense a second length of the material sheet;
locking the material sheet tensioning dispenser in a second location on the work table after moving the material sheet tensioning dispenser the second distance; and
locking the material roll within the material sheet tensioning dispenser using the tensioning system after locking the material sheet tensioning dispenser in the second location.

15. The method of claim 14 further comprising:
moving the movable carriage in the direction parallel to the longitudinal axis of the longitudinal component a second distance towards the material sheet tensioning dispenser to guide at least a portion of the second length of the material sheet around the longitudinal component.

16. The method of claim 9, wherein positioning the longitudinal component over the first length of the material sheet further comprises positioning the longitudinal component over longitudinal component support rollers of the material sheet tensioning dispenser.

17. The method of claim 16 further comprising:
moving the material sheet tensioning dispenser a second distance away from the movable carriage to dispense a second length of the material sheet after wrapping at least a portion of the first length of the material sheet around the longitudinal component, wherein the longitudinal component rolls over the longitudinal component support rollers as the material sheet tensioning dispenser moves relative to the work table.

18. A material sheet tensioning dispenser comprising:
a positional lock configured to maintain a position of the material sheet tensioning dispenser relative to a work table;
a material roll support configured to rotatably support a material roll; and
a tensioning system configured to selectively prevent rotation of a material roll on the material roll support.

19. The material sheet tensioning dispenser of claim 18, wherein the tensioning system comprises a clamp configured to engage with a material roll on the material roll support.

20. The material sheet tensioning dispenser of claim 19, wherein the clamp comprises at least one of an air chuck or an expandable mechanical chuck.

21. The material sheet tensioning dispenser of claim 18, wherein the tensioning system comprises a tension lock configured to selectively disengage to allow rotation of the material roll, wherein the tension lock comprises at least one of a ratchet and pawl or a magnetic lock.

22. The material sheet tensioning dispenser of claim 18 further comprising:
a material film supporting roller configured to support a material sheet as the material sheet is dispensed from the material roll.

23. The material sheet tensioning dispenser of claim 22, wherein the material film supporting roller comprises a rotational axis higher than a rotational axis of the material roll support relative to the work table.

24. The material sheet tensioning dispenser of claim 22, wherein a frame comprises the material film supporting roller, and wherein the frame is movably connected to the material sheet tensioning dispenser to access the material roll support.

25. (canceled)
